(19) United States
(12) Patent Application Publication
(10) Pub. No.: US 2007/0253042 A1
(43) Pub. Date: Nov. 1, 2007

(54) High Data Density Volumetic Holographic Data Storage Method and System

(75) Inventors: Gabor Szarvas, Budapest (HU); Pal Koppa, Veszprem (HU); Gabor Erdei, Budapest (HU); Laszlo Domjan, Budapest (HU); Peter Kallo, Budapest (HU)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING S.A., Boulogne-Billancourt (FR)

(21) Appl. No.: 10/556,624

(22) PCT Filed: May 14, 2004
(86) PCT No.: PCT/HU04/00052

§ 371 Date: Oct. 2, 2006

(30) Foreign Application Priority Data
May 15, 2003 (HU) P 03 01354
Feb. 12, 2004 (HU) P 04 00413

(51) Int. Cl. G11B 7/0065

(52) U.S. Cl. 359/22

(57) ABSTRACT

The object of the invention is a high data density holographic data storage method. The holograms are written into the volumetric data storage layer or layers, and during the writing process the accurate places of holograms in the data carrier structure are determined by the intersection domain of the object and reference beam or beams, and during the reading process the selection of holograms simultaneously illuminated by the reference beam or beams, the read-out of the addressed hologram, and the suppressing of un-addressed holograms are carried out by a spatial filter located confocally with the addressed hologram and/or by satisfying the Bragg condition. The optical arrangement for recording and reading out holograms has three dedicated planes in confocal arrangements, where the addressed hologram is in the middle dedicated plane in the storage material, and in the two outer dedicated planes there are spatial filters. The optical arrangement is a 12f optical System consisting of three pairs of objectives.

### FIELD OF THE INVENTION

The invention describes a new kind of holographic data storage system, which is capable of obtaining a capacity of 200 to 800 Gbytes using a disc of 1 to 3 mm thickness and 120 mm diameter. The system presented here achieves the high capacity by means of 3-dimensional multi-layer holographic data storage. High-speed reading is ensured by parallel reading and by the disc format. Addressing of various layers in the system is implemented by means of a confocal optical arrangement, which, at the same time, also filters out holograms that are read but un-addressed. The addressed hologram and a spatial filter are arranged in a confocal optical system.

### BACKGROUND OF THE INVENTION

When comparing the data storage possibilities available in our days, it can be stated that, in the field of data storage using e.g. CD and DVD, one of the feasible ways to increase the capacity is the reduction of wavelength, which involves the trend towards the UV spectrum. This, however, raises a number of problems in the field of illumination, mapping and possibility of detecting. Another possible solution is the 3-dimensional spatial data storage.

Even within the spatial data storage, the patents and papers so far deal with two further possibilities. One possibility is the generalization of the above-mentioned bit-oriented system known from CD and DVD to 3 dimensions. The main problem of such systems, namely the noise due to dispersion, is suppressed by means of a so-called confocal filter. The noise suppression, however, is dependent on the number of layers. In practice, two-layer systems became popular. At an experimental laboratory level, systems of up to about ten layers were tested. In addition to noise that may occur, other problems need also be taken into account. The most significant problem is that, in case of a bit-oriented multi-layer disc, 3-dimensional servo systems have to be developed.

Another solution for spatial optical data storage that has been examined for very long time is the storage of multiplexed holograms in a thick storage material. The main problems of utilizing multiplexing are: it requires a large M# number of holographic materials with invariable size, high precision drives and expensive optical elements. The system described here combines the two systems mentioned here, i.e. the digital multi-layer systems and the multiplexed thick holographic data storage systems, so as to underline their advantages and reduce their problems. The essence of the solution is that the data are stored in the form of individual or Fourier holograms in a stratified structure and addressed by using a confocal arrangement. In addition, the confocal arrangement allows the holograms that are un-addressed but read by using the same reference beam to be filtered out. Basically, this does not require materials of strictly invariable size and, in addition, requires only simpler servo systems.

The patent U.S. Pat. No. 5,289,407 describes a confocal microscope-based 3-dimensional multi-layer system suitable to be used for optical data storage, which writes and reads data bits into and from a photo polymer. Basically, the system uses the principle of confocal filtering for reading the addressed bit. The essential difference of the system according to the present invention is that a micro-hologram containing dozens or hundreds of bits is addressed instead of addressing a single bit. Compared to a system of this kind, it can be obviously stated that, assuming the same data density, writing multi-layer thin holograms requires a one order less servo system; in fact the size of a hologram is by one order higher than that of a stored bit. While the system described in the literature referred to sets a requirement of ±0.1 μm accuracy to the servo system, the system according to the invention requires a servo system of ±1 μm accuracy, due to the Fourier type holograms. In the present system the speed of both writing and reading is higher as a result of parallel access.

According to the patent U.S. Pat. No. 6,212,148, the storage of digital data bits is implemented in a pre-formed reflection hologram. The pre-written holograms are embedded in a nonlinear photosensitive material. During writing of the data bits, the reflection of the pre-written hologram is reduced and discontinued, respectively, in small ranges at the focal point of the writing laser beam as a result of the absorption of the nonlinear material, thus memorizing the bit written in. During reading, the change in reflection of the addressed range carries the information. The precondition of the accurate reading is that the grid system of the pre-written thick hologram is well adapted to the wave front of the reading signal, i.e. the Bragg's condition has to be fulfilled with high accuracy during reading. It can also be stated that the multi-layer micro-hologram type storage sets less requirements to the servo system in case of the same capacity. Both the writing and reading are also serial in the patent U.S. Pat. No. 6,212,148.

The document US 2002/0015376 A1 provides a solution to improve the current CD technology so as to become suitable to be used for writing and reading micro-holograms. The material applied on the disk and suitable for holographic storage serves for storing the bits written in a holographic way. Each hologram stores a single bit, which ensures the trouble free application with the existing CD/DVD technology. In order to reduce the interference that appears when reading the addressed bits, the document describes the application of a spatial filter of hologram size. The addressing between the layers is implemented by moving an appropriate pair of lenses. Thus, in its essence, the document replaces the existing bit-oriented data storage by holographic elementary grid, based on the existing CD/DVD technology. When comparing the present invention and the document US 2002/0015376 A1, basically two essential differences exist: on the one hand, the invention proposes that more than one bit is written into one hologram, which allows a parallel data flow and requires a simpler servo system. On the other hand, the confocal filter used in the document US 2002/0015376 A1 only reduces the interference between the individual holograms instead of eliminating it. This limits the maximum number of micro-holograms illuminated by using the same reference beam. With the solution according to the present invention, there is no interference between the individual micro-holograms in a geometric-optic sense.

The document WO 02/21535 presents a holographic data storage system, which places spatial holograms in two dimensions. The interference between the holograms is eliminated by means of a Gaussian beam of properly selected parameters. The size of a hologram is adjusted by setting the size of the Gaussian beam neck. The hologram is established within the space determined by the reference beam, while the neighboring holograms fail to be deleted to a considerable extent, due to the low intensity of the object beam in relation to the reference beam. The confocal arrangement means that the focal planes of both the object beam and the reference beam coincide. In this document, the emphasis is placed on the wave front of the reference beam and the spatial hologram, in contrast to the holographic system using a multi-layer thin storage layer where the confocal arrangement aims at separating the holograms that are read but un-addressed from those that are addressed. In the document WO 02/21535, the principle of confocal filtering is not used, i.e. the system fails to contain a well-defined aperture, which does not transmit the light coming from the read but un-addressed holograms.

The paper titled “Multilayer volume holographic optical memory” (Optics Letters Feb. 15, 1999/Vol. 24. No. 4) describes a volume holographic system, which is suitable to be used for establishing a virtual multi-layer structure. The holographic system relies on a special reference beam, which is accessible through a diffuser placed into the reference beam. The micro-holograms serving for the storage of data are spatially separated to form layers. The diffuse reference reaches more holograms at the same time. However, only one of them is read, namely the one with a high correlation between the writing and reading reference beams. The presented calculations show that both the lateral and the longitudinal selectivity prove to be sufficient to place the holograms in 3-D. As a summary, it can be stated that the special reference beam used enables micro-holograms to be arranged in virtual layers, thus ensuring the possibility of addressing in a simple way, the high data density and the simple reading. Also in this case ensuring the good correlation requires very accurate servo systems.

The paper titled “Multilayer 3-D memory based on a vectorial organic recording medium” (SPIE Vol. 1853, 1993) describes a multi-layer holographic system based on polarization holography. The holographic layer structure presented is built of Pockels cell, storage medium and polarizer repeated periodically in threefold layers. Addressing of the individual layers is based on setting the appropriate polarized state which can be obtained by means of the Pockels cell and the polarizer. The polarization hologram underlying the above described system ensures the highest possible diffraction efficiency and, therefore, a high signal-to-noise ratio as well. It is an advantage that the interference between the memory layers is negligible. In fact, the polarized state enables a single and only a single layer to be selected. The described system has the advantages offered by the Fourier holograms. In fact, the offset invariance of holograms does not require the use of accurate focus and track servos. The presented solution, however, fails to deal with the handling of errors caused by the maladjustment of data layers and the difficulties caused by the size increase during multiplying the relatively robust layers as well as the possibility of manufacturing the relatively complicated layer structure.

The patent U.S. Pat. No. 6,020,985 describes a multi-layer optical data storage system in which the digital data bits are stored in the form of reflection micro-holograms. The reflection holograms controlled by a servo system are produced when the reference beam meets the object. The spherical aberration appearing in layers of various thicknesses is compensated by a special optical pair. A high data transfer rate can be obtained by means of mutually incoherent lasers reading several tracks together. This solution also sets severe requirements to the servo system.

### SUMMARY OF THE INVENTION

The data carrier consists of a stratified or homogeneous light sensitive storage material of 1 to 3 mm thickness and supporting and/or covering layers of 0.05 to 1 mm thickness to ensure the proper mechanical strength. The data carrier is either transparent or reflective. In case of a reflection type data carrier, a reflective layer is arranged at the boundary surface between the storage layer and the supporting layer.

In case of stratified storage material, spacer layers of 10 to 500 μm thickness are placed between the storage layers of 1 to 100 μm thickness, depending on the number of layers used. In case of homogeneous storage material, the distance between the holograms written below each other (layers) is 10 to 500 μm. In another embodiment, a stratified or homogeneous light sensitive storage layer is arranged on each side of the data carrier. In such cases, both sides of the supporting layer are of reflective design. The two light sensitive layers of 0.5 to 1 mm thickness are independent. The light does not pass through the reflective layers. The capacity of the two-sided disc is twice as high as that of the single-sided disc. The format of the data carrier may be disc, card or tape.

The central element of the optical system is a writing/reading Fourier objective. As the object and reference beams travel very different distances from the writing objective to the data carrier and from the data carrier to the reading objective, respectively, during writing and reading of the layers situated below each other, the writing/reading Fourier objective is complemented with asymmetric compensating plates whose size and/or thickness depends on the depth of the addressed layer and/or of various optical properties, to compensate the different lengths of the optical paths. The compensating plates are placed in front of the writing/reading Fourier objective and/or between the data carrier and the objective or even within the objective itself. The use of compensating plates of properties (shape, thickness etc.) depending on the depth of the layers enables the layers to be addressed independently of each other.

### BRIEF DESCRIPTION OF THE DRAWINGS

FIG. 1 shows an 8f optical system according to the invention;

FIG. 2 shows the operating conditions for the confocal filtering of holograms;

FIG. 3 shows a 12f optical system with three confocally arranged Fourier planes;

FIG. 4 shows a folded 12f system;

FIG. 5 shows another embodiment of the optical system;

FIG. 6 shows the confocal splitting of the hologram to be read out in the addressed layer and the holograms in the un-addressed layers;

FIG. 7 shows an embodiment employing dual wavelength polarization holography;

FIG. 8 shows the layer addressing process with different thickness compensating plates;

FIG. 9 shows the layer addressing process in the case of a folded 12f system;

FIG. 10 shows an embodiment where the data carrier plate is located in a slanted way between the objectives;

FIG. 11 shows a modified 12f system;

FIG. 12 shows a reflection type optical system with collinear optical arrangement;

FIG. 13 shows magnified pictures of parts of the 12f optical system;

FIG. 14 shows the process of writing the holograms into different depths of layers;

FIG. 15 shows a schematic view of the real image of the SLM and of the addressed layer;

FIG. 16 shows the cross section of the data carrier;

FIG. 17 shows the reading process;

FIG. 18 shows a schematic view of variable shape or variable optical characteristics compensating plates;

FIG. 19 depicts the schematic view of a variable thickness compensating plate;

FIG. 20 shows mobile linear elements; and

FIG. 21 shows a schematic view of the possible arrangements of the object and reference beams.

### DETAILED DESCRIPTION OF PREFERRED EMBODIMENTS

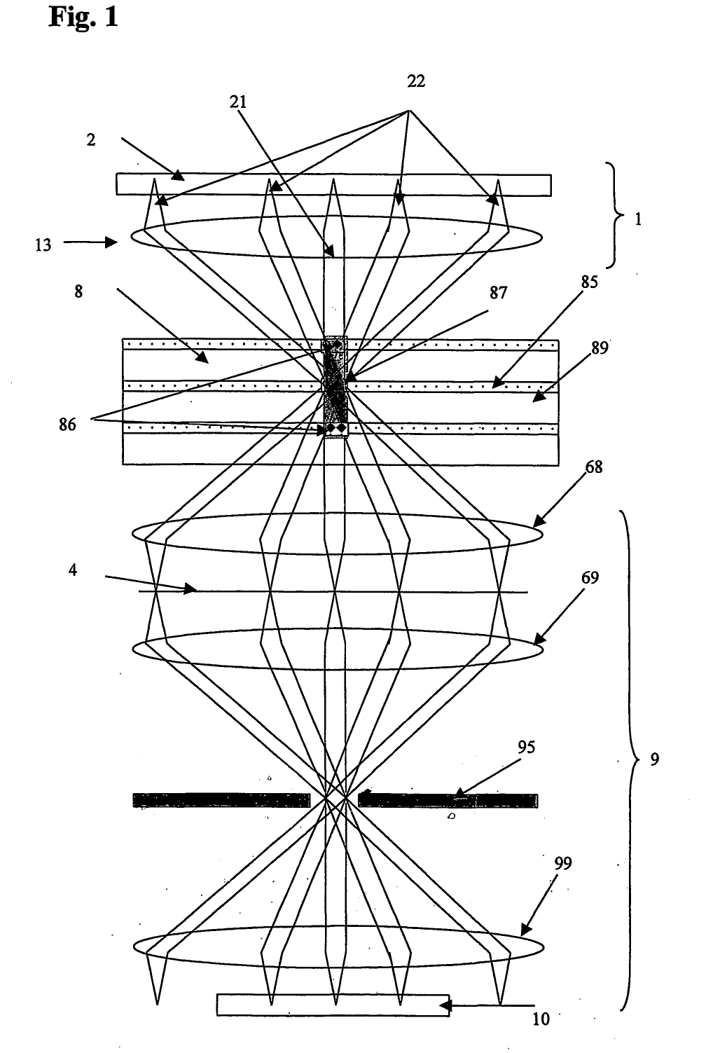

The optical system shown in FIG. 1 is a complex 8f system, which consists of four different objectives. The elements of each objective may be expediently identical. The first Fourier objective 13 generates the Fourier transform of the object (SLM, spatial light modulator) and the second member retransforms the object. The image of the object is created in the back focal plane of the second Fourier objective 68. The SLM 2 located in the first focal plane of the first objective serves for writing the data. The first focal plane of the third Fourier objective 69 coincides with the back focal plane of the second Fourier objective 68. The image of the SLM is in this plane 4. This image is transformed to the back focal plane by the third Fourier objective 69. The fourth Fourier objective 99 retransforms the image of the SLM. Hence, the image of the SLM appears again in the back focal plane of the fourth Fourier objective. This is where the detector array 10 is located. The data carrier 8 is in or near the common focal plane of the first 13 and the second 68 Fourier objectives. The image of the common focal plane of the first and second Fourier objectives is in the common focal plane of the third and fourth objectives. This means that the focal planes (Fourier planes) are the images of each other. In other words, the Fourier planes are in a confocal arrangement. In the stacked layers of the stratified storage material, in a column normal to the disk surface, there is a hologram in each storage layer. In the common focal plane of the third and fourth objectives, the confocal filter (spatial filter) 95 is situated, which screens the light beams coming from the un-addressed holograms. The addressing of each layer during reading and writing can be implemented by the interrelated displacement of the data carrier 8 and the optical system. During the addressing process, the optical system moves as a rigid unit normal to the plane of the data carrier 8. The confocal filter 95 can be made as a conventional aperture or with Gauss apodisation. In the latter case, the cross-talk between layers can be further reduced. In this embodiment, the reference beam 21 travels along the common optical axis of the objectives, in a direction identical with that of the object beam. The reference beam is a dot (pixel) in the centre of the SLM in the plane of the SLM, while in the confocally located Fourier planes it is a clipped (aperture limited) planar wave traveling in parallel with the common optical axis of the objectives. In the centre of the object beam 22, an appropriate size void is to be left for the reference beam 21. In the Fourier plane this means that the object beams travel in a cone, which has a ‘hole’ along its axis. This means that there is an angular range—an inner cone within the cone generated by the object beams—in which no object beam may travel. In the Fourier planes (at the place of the addressed hologram 87 and the confocal filter 95), the object beam 22 and the reference beams 21 intersect each other. In the focus plane of the first Fourier objective, during the writing process there is an addressed photosensitive layer. This is where the object and reference beams meet, i.e. in this layer a transmission hologram that is the addressed hologram 87 is generated.

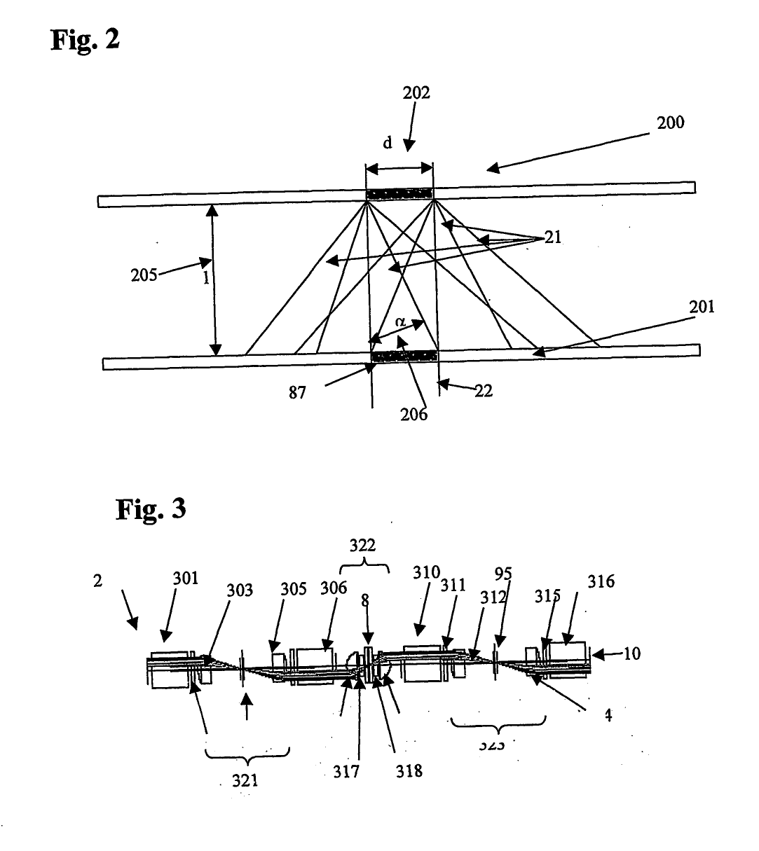

FIG. 2 shows the operating conditions for the confocal filtering of holograms. It is a read-out condition that no coupling is established between the holograms located in layers one above the other (200 and 201), i.e. the signal of an object wave coming from only one hologram reaches the detector. The confocal filter 95 located in the focus plane of the third Fourier objective ensures this. For the confocal splitting of the hologram to be read out in the addressed layer and the holograms in the un-addressed layer, and for the spatial filtering of un-addressed holograms, the following equation has to be satisfied:

$$\frac{d}{l} = tg α ,$$

where
d is the diameter (202) of the holograms,
l is the distance (205) between layers, and
α is the half conic angle (206) of the inner cone not filled up by the object beams.

In this case, the object beams originating from the layers below and above the addressed hologram 87, whose holograms are also read out by the reference beam 21, cannot pass the spatial filter 95 in the focal plane of the third Fourier objective. Consequently, only the object beam of the hologram located in the addressed layer and read out by the reference beam reaches the detector 10, in accordance with FIG. 1.

In a different embodiment, the reference beam traveling along the common optical axis of the objectives and the object beams move opposite each other. In this case, a reflective hologram is created in the addressed layer. The addressing, read-out and the spatial filtering of the holograms in the un-addressed layers are carried out similarly to the description above.

The optical arrangement shown in FIG. 3 is basically the same, but offers new opportunities. The advantage of the 12f system is that a spatial filter 304 is placed in the first Fourier plane. The second and third Fourier planes create a sharp image about this. The storage material is in the second Fourier plane 8, and another spatial filter is located in the third Fourier plane 95. The size of the hologram is adjusted by the first spatial filter 304, because the spatial filter only allows certain specified Fourier components to pass (low-pass filter). By adjusting the hologram size, the data density is adjusted in the relevant hologram. Of course, there is a limit to reducing the size of the hologram, because the resolution deteriorates with decreasing size. Consequently, also the number of pixels that can be distinguished on the detector decreases. This can be counterbalanced and optimized by special coding.

The exact operation of the 12f optical system shown in FIG. 3 will be described below. The 12f system is a complex unit, which in a general case consists of three pairs of different objectives. Consequently, in a general case the system comprises six objectives. The elements of each objective pair can be expediently identical. Therefore, there are altogether 2×3 Fourier objectives in the system. The first member of an objective pair always creates the Fourier transform of the object (SLM) and the second member retransforms the object. In the back focal plane of the second member, the image of the light modulator 2 (SLM) is always created. The SLM 2 serves for writing the data, and it is located in the first focal plane of the first objective pair 321, in the inner common focal plane of which there is a spatial filter aperture 304, which clips the higher orders of the Fourier transform of the SLM, and only passes one part of the zeroth diffraction order. Therefore, in the back focal plane of the second Fourier objective 305, an SLM image already filtered spatially (low pass filter) appears. This Fourier filter is used for increasing the data density. The first focal plane of the first member (third Fourier objective 307) of the second objective pair 322 coincides with the back focal plane of the second member of the first objective pair 321 (second Fourier objective 305). This is the plane where the SLM image filtered by the low pass filter appears. This image is Fourier transformed by the first member of the second objective pair 322 (third Fourier objective 307) to the common focal plane of the third 307 and fourth 309 objectives. The second member of the second objective pair 322 (fourth Fourier objective 309) retransforms the SLM image. Therefore, in the back focal plane of the second objective pair 322, the SLM image that has already passed through the low pass filter appears again. The data carrier 8 is in or near the common inner focal plane of the second objective pair 322. Between the two objectives (third Fourier objective 307 and fourth Fourier objective 309) of the second objective pair 322, before and after the data carrier layer 8, there are two variable thickness plane parallel plates 317 and 318. The data carrier 8 moves (turns) between these two plates in its own plane. The first focal plane of the third objective pair 323 coincides with the back focal plane of the second objective pair 322. The spatially filtered image of the SLM 300 is in this plane. This image is Fourier transformed by the third objective pair 323 into the common focal plane of the objective pair elements. The second element of the objective pair (the sixth Fourier objective 314) re-generates the filtered image of the SLM in the back focal plane of the objective pair 323. This is where the detector array 10 is located.

The aperture image of the spatial filter 304 in the inner common focal plane of the first objective pair 321 is in the inner common focal plane of the second objective pair 322. The data carrier 8 (micro-hologram) in principle registers the sharp image of the spatial filter aperture 304. The image of the inner common focal plane of the second objective pair 322 is in the inner common focal plane of the third objective pair 323, where the second spatial filter 95 is located. In other words, the three inner focal planes (Fourier planes) and hence the spatial filter apertures 304 and 95 are the sharp images of each other. In still other words, the Fourier planes are in a confocal arrangement. In the common focal plane of the third objective pair 323, the second spatial filter 323 is located. According to the previous discussion, this coincides with the image of the first spatial filter 304.

In the stacked layers of the stratified storage material, in accordance with FIG. 1, in a column normal to the disk surface, there is a hologram in each storage layer: the addressed 87 and the un-addressed 86 holograms. The addressing of each layer is implemented during the reading and writing process by the interrelated displacement of the data carrier 8 and the reading and writing optical systems 1 and 9. During the addressing, the reading and writing optical systems 1 and 9 move as a rigid unit normal to the plane of the data carrier 8. The spatial filters 304 and 95 may be made as a conventional apertures or with Gauss apodisation. In the latter case, the cross-talk between layers is further reduced.

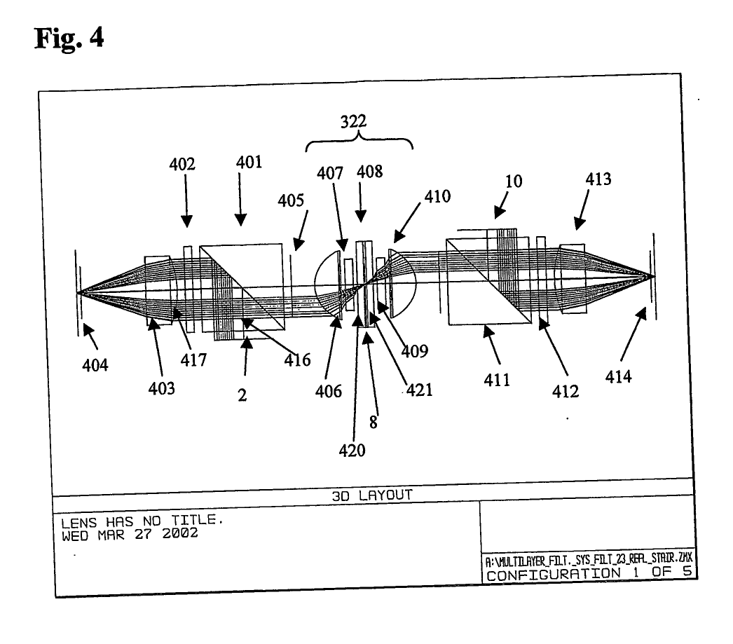

For the 12f system, it is necessary to reduce the number of objectives from six to four, and the linear size of the system may also be reduced to about one half, if—through the application of polarization beam splitting cubes—the system is folded in a way shown in FIG. 4. In this case, the first and last objective pairs 321 and 323 of the 12f system shown in FIG. 3 consist of the Fourier objectives 403 and 413, in the back focal plane of which there are mirrors 404 and 414 having a well-defined aperture. Hence, the light reflects back from the mirrors 404 and 414 and travels through the objectives 403 and 413 twice. This means that in this case the same objective carries out the Fourier transformation and retransformation. Consequently, the Fourier transform of the SLM image appears on the mirrors 404 and 414. In the folded system, the mirrors having a defined aperture clip the light beams reaching them. Two λ/4 plates 402 and 412 are located between the objectives 403 and 413 and the beam splitting cubes 401 and 411, respectively. The polarization direction of the light turns by 90°, after traveling twice across the plate. Therefore, the light travels across the polarization beam splitting layer in one case, and is reflected in the other. The reference beam 416 travels within the object beam 417. Similarly to the system shown in FIG. 1, the object beams 417 represent a light cone with a hole in the middle along its axis. The object and reference beams are coupled by a beam splitting prism 401, and they are decoupled by another beam splitting prism 411.

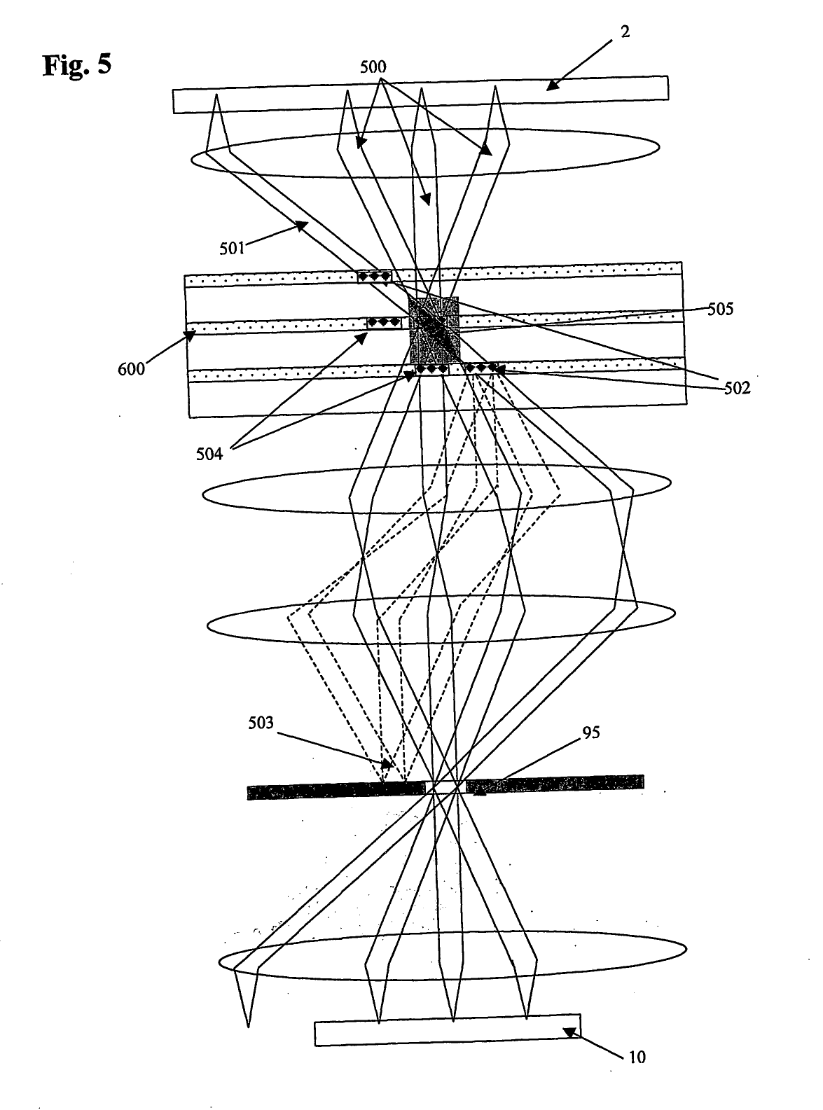

According to the embodiment shown in FIG. 5, the reference beams 501 include an angle γ with the common optical axis of the objectives in the Fourier planes. The object beams 500 travels within a semi-conic cone with an angle β in the Fourier plane, and the object pixels are located within a circle of radius R in the image and object space (the plane of the SLM 2 and that of the detector array 10). The reference beam 501 is outside the circle of radius R in the SLM plane. During the read-out, the reference beam 501 reads out several holograms also in this case simultaneously. Therefore, the simultaneously read out holograms 502 are located in stacked layers, shifted by the angle γ.

FIG. 5 shows the filtering of read out but un-addressed holograms in the case of a slanted reference beam. Here, the reference beam 501 reads out the un-addressed holograms 502 in addition to the addressed hologram 505. The spatial filter 95, situated confocally with the addressed hologram 505 and located in the back focal plane of its third Fourier objective 69, only lets the object beams pass if they come from the addressed hologram 505. The unaddressed hologram 503 is filtered by the spatial filter 95. Therefore, only the object beam of the hologram read out by the reference beam and located in the addressed layer 600 reaches the detector 10.

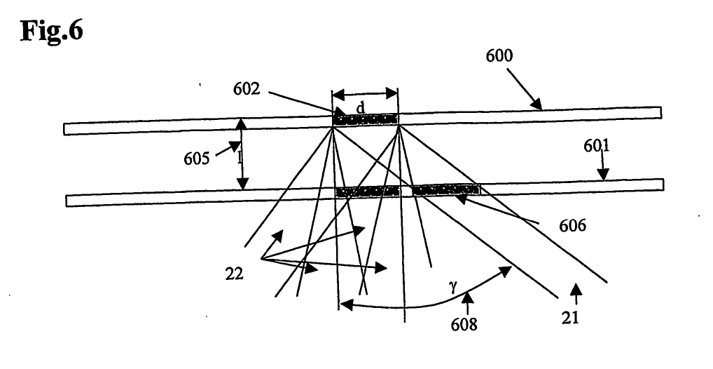

In a way shown in FIG. 6, for the confocal splitting of the hologram to be read out in the addressed layer 600 and the holograms in the un-addressed layers 601, in addition to the spatial filtering of the un-addressed holograms 606, the following equation has to be satisfied:

$$\frac{d}{l} = tg γ ,$$

where

d is the diameter (602) of the holograms,

l is the distance (605) between the various layers, and

γ is the angle (608) of the reference beam.

In another embodiment, the reference beam and the object beams traveling along the common optical axis of the objectives move opposite each other. In this case, a reflective hologram is created in the addressed layer. The addressing, reading out and the spatial filtering of the holograms of un-addressed layers are carried out similarly to the description above.

In the embodiment depicted in FIG. 1, it is also possible to perform wavelength multiplexing, a procedure well known in holographic data storage. For example, if the thickness of each storage layer reaches 20-25 μm, three light sources deviating with a wavelength of Δλ≈8 μm or a tunable laser diode can be applied (the three light sources are not shown in FIG. 1). Hence, the data volume that can be stored in a micro-hologram is increased by several magnitudes. Such a light source can be for example a tunable blue laser diode.

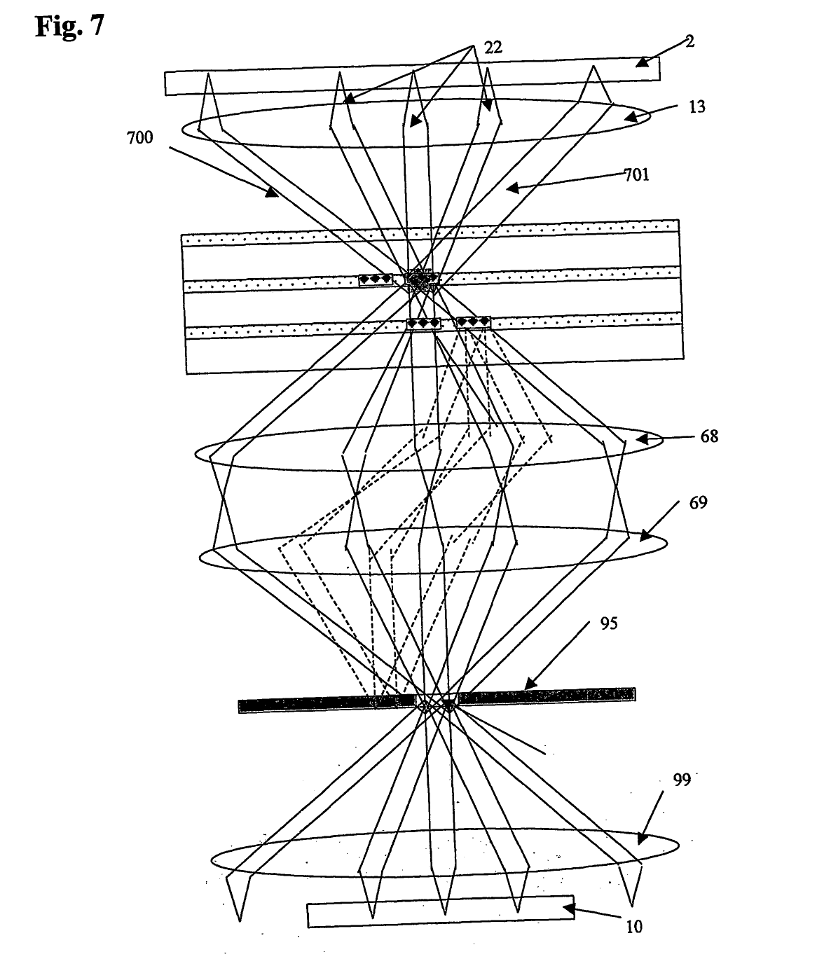

In the embodiment shown in FIG. 7, dual wavelength polarization holography is applied. In this case, in addition to the reference beam 700, another sensitizing beam 701 of a wavelength deviating from that of the object beam 22 and the reference beam 700 are also used. For the coherent object/reference beam light source, it is advisable to use a low price and high output red laser diode with λ=635-670 nm. As a sensitizing light source, a low price blue laser diode or LED can be used. The wavelength of blue laser diodes and LEDs is in the range of λ=390 nm to λ=450 nm. The laser diodes are not shown in FIG. 7.

For each embodiment mentioned above, the various layers can be reached by moving the read/write head. The problem caused by varying thickness stemming from the addressing of various layers can be compensated by using a variable thickness plane parallel plate. This plate has to be fitted between the Fourier objective and the data carrier plate. The thickness of the plane parallel plate must be changed in a stepwise way, depending on the distance between the storage layers and the data carrier surface. In this way, the spherical aberration arising due to the change in the thickness of the data carrier can be compensated. This is depicted in FIG. 4. The joint thickness of the plane parallel plates located between the two elements of the second (medium) objective pair 322 have to be constant during the addressing before and after the focal plane. This means that the total thickness of the range of data carrier plate 8 before the focal plane 420 plus the thickness of the first compensating plate 407 before the data carrier plate 8 plus the range of the data carrier plate behind the focal plane 421 and the thickness of the second compensating plate 409 after the data carrier plate 8 have to be constant. Therefore, simultaneously with the displacement of the optical system, the thickness of the compensating plates 407, 409 before the storage plate and after the storage plate also have to be varied. The object/image relations and the interrelated positions of the elements 404, 408 and 414 (Fourier planes) do not change by displacing the optical system normal to the plane of the data carrier plate and by fitting the compensating plates 407 and 409 of appropriate thickness.

By displacing the optical system and inserting the compensating plates, it is always exactly one layer of the storage plate, which will be addressed. Hence, the read out hologram (the hologram located in the inner, common focal plane of the second objective pair 322 in FIG. 3) is in a confocal relationship with the second spatial filter 95 located in the inner, common focal plane of the third objective 323. The read out hologram travels on without any change through the spatial filter 95. The beams coming from the holograms also read out by the reference and located in the un-addressed layer cannot pass the second spatial filter 95.

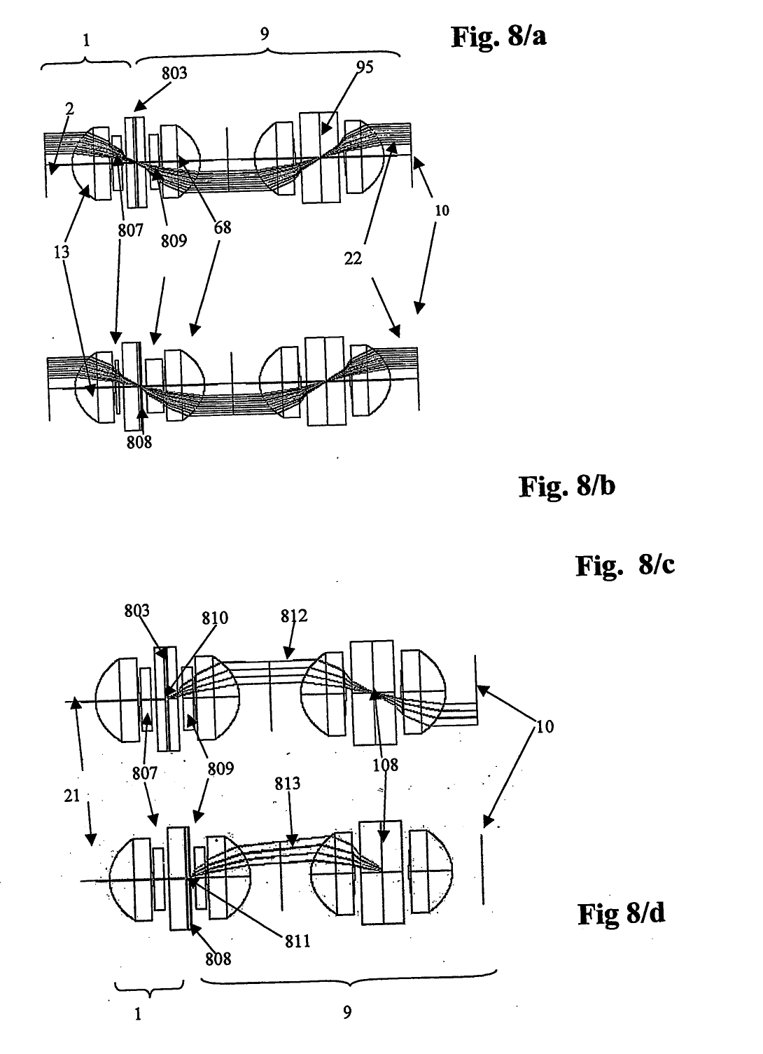

According to one possible embodiment of the compensating plates, they are parallel glass sheets in the optical system with gradually changing thickness, in accordance with FIG. 8. The plates 807 and 809 may be turned so that they are positioned between the first and second Fourier objectives 13, 68. During the reading and writing process, the addressing of each layer is carried out by displacing the optical system and by turning to the compensating plate with the appropriate thickness. In FIG. 8/a, the compensating plates 807 and 809 are of identical thickness. Accordingly, the holographic layer 803 in the middle is in a confocal position with the confocal filter 95. FIG. 8/b shows a position where the compensating plate 807 is thinner than the plate 809. In this case, the external holographic layer 809 is in confocal position with the confocal filter 95. The FIGS. 8/c and 8/d show the process of read-out. The reference beam 21 passes through all the storage layers, and therefore also through the middle holographic layer 803 and the external holographic layer 808. The reference beam reads out the addressed hologram 810 and also the un-addressed hologram 811, as well as all the other holograms, which are located one behind the other in the layers that are not shown in the drawing. In this case the compensating plates 807 and 809 are of an identical thickness. The writing optics 1 and the reading optics 9 are displaced in a way that the addressed hologram 803 and the filter 95 are in a confocal position, and therefore the read out object beam 812 coming from the addressed hologram 810 travels across the confocal filter 95, and then reaches the detector array 10. The object beam 813 read out from the un-addressed hologram 811 may not pass through the confocal filter 95.

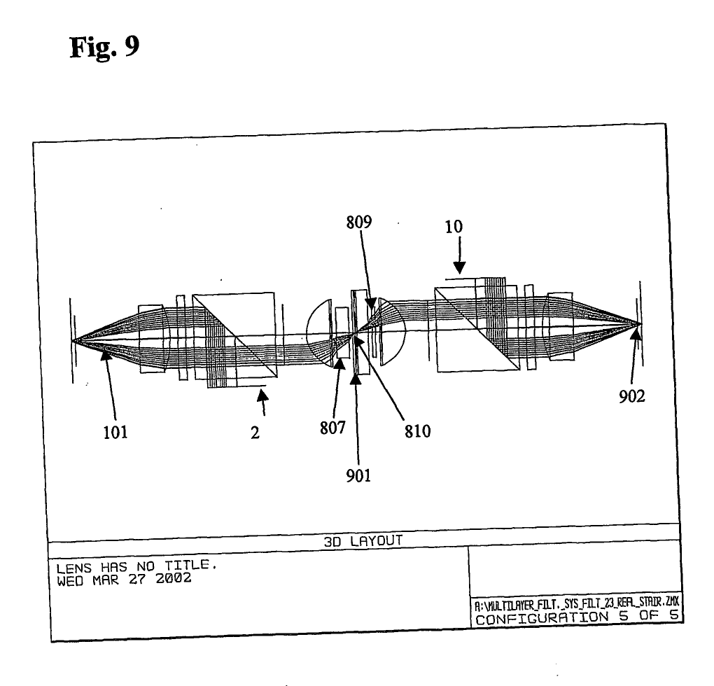

FIG. 9 shows the addressing process in the case of a folded 12f system. In this case the first compensating plate 807 is thicker than the second compensating plate 809. Here the first holographic layer 901 in the first part of the storage plate is addressed. Now the role of the confocal filter is taken over by the confocal mirror 902 having a well defined size of aperture. In other words, the addressed hologram 810 and the mirror 902 are in a confocal position.

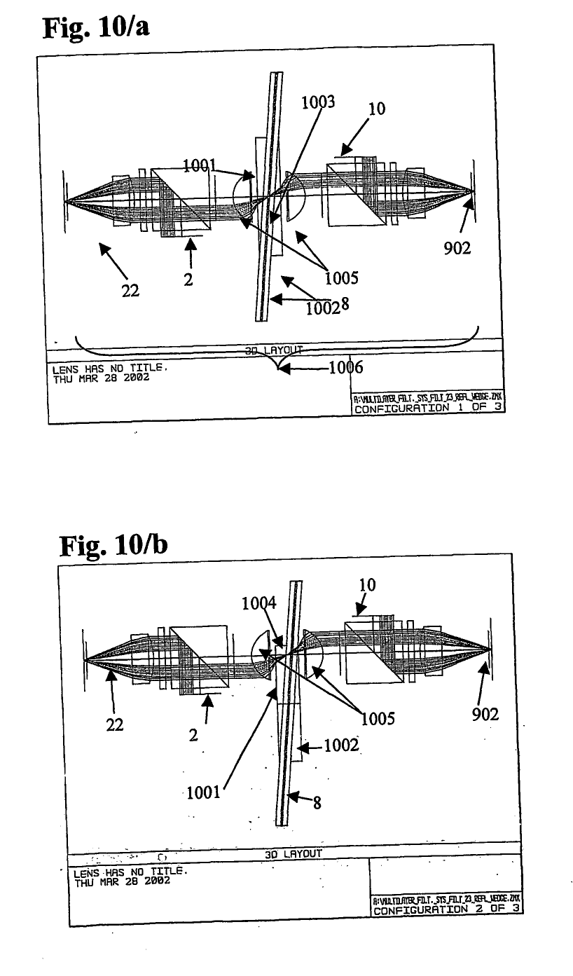

In the embodiment shown in FIGS. 10/a and 10/b, the data carrier plate 8 is located in a slanted way between the objectives 1005. Between the data carrier plate 8 and the objective 1005 on both sides, there is a transparent optical quality wedge, the first compensating wedge 1001 and the back compensating wedge 1002. The angle of the wedges 1001 and 1002 is identical with the angle included by the data carrier plate 8 and the optical axis of the objectives 1005. The wedges 1001 and 1002 are fitted into the cartridge, which houses the plate. The cartridge is not shown in the drawing. As against the objective 1005, the cartridge is stationary with the wedges, and the data carrier plate 8 turns in the cartridge. Between the data carrier plate 8 and the wedges 1001 and 1002, there is a thin (1-2 μm thick) refractivity matching liquid film. The cartridge is sealed by the manufacturer to make sure that the matching liquid does not leak. The thickness of compensating wedges 1001 and 1002 varies in the direction of rotation of the data carrier plate. The thickness of one wedge increases, and the thickness of the other one decreases. The sides of the wedges 1001 and 1002 opposite the data carrier plate 8 are parallel to each other and normal to the optical axis. The two wedges and between them the data carrier plate from an optical point of view together represent a plane parallel plate. In FIG. 10/a, the optical head is located in a way that the thicknesses of the two wedges are identical on the two sides of the plate. Therefore, the hologram 1001 in the middle of the data carrier plate is addressed. In this case the addressing of the layers can be implemented by turning the whole optical head 1006 in the direction of rotation of the data carrier plate 8. When the optical head 1006 is turned in the direction of rotation of the data carrier plate, the thickness of one edge decreases, and the thickness of the other edge is increasing. In FIG. 10/b, the head is displaced in a way that the first compensating wedge 1001 before the data carrier plate 8 is thicker, and the back compensating wedge 1002 after the data carrier plate is thinner. In this case the outermost hologram 1004 in the data carrier plate half closer to the SLM is addressed.

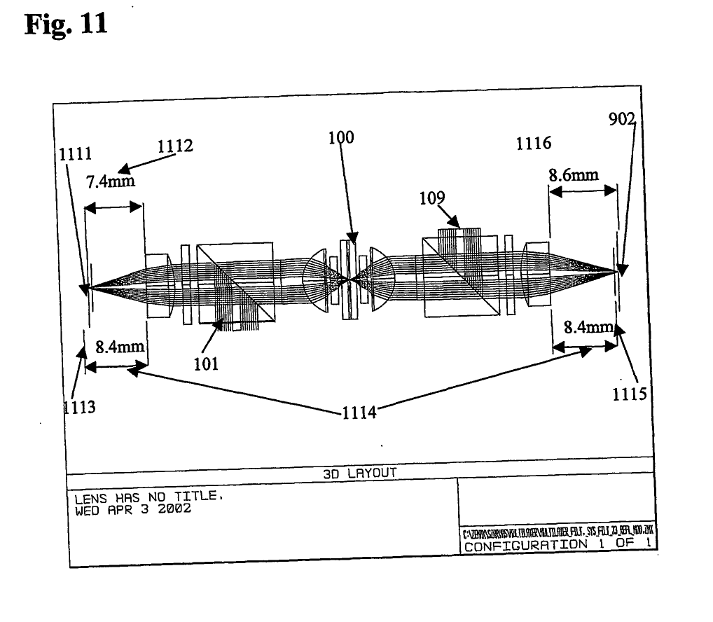

In accordance with the embodiment shown in FIG. 11, the addressing can be implemented by the slight distortion of the planar wave illuminating the SLM. Instead of a planar wave, the SLM is illuminated by a spherical wave of varying radius of curvature (±10-±1000 m). By changing the radius of curvature of the wave front, the diameter of the beam increases in the Fourier planes. The smallest beam cross section is generated before or after the theoretical Fourier planes, subject to the sign of the curve of the wave front illuminating the SLM. The addressing carried out by a spherical wave front is described by showing an actual example. In the modified 12f system shown in FIG. 11, the SLM is illuminated by a spherical wave not shown in the drawing. In the original 12f system, the SLM is illuminated by a planar wave. In the original 12f system, the distance of the theoretical Fourier planes 1113 and 1115 is 8.04 mm from the very last glass surface. In the original system, the spatial filters are located in these planes. In the modified system shown in FIG. 11, the distance of the filter 1111 from the very last glass surface is modified to 7.4 mm, and the distance of the confocal mirror 902 (the second spatial filter) from the very last glass surface is modified to 8.6 mm. The place of the hologram (the lowest diameter point) has been displaced in the storage material by 0.15 mm as against the theoretical Fourier plane. The numerical example shown demonstrates that if the spatial light modulator is not illuminated by a planar wave, the smallest beam cross sections are shifted from the theoretical Fourier plane of Fourier objectives. Consequently, the addressing can be implemented in this case by the appropriate displacement of the spatial filter 1111 and the confocal mirror 902. In this case the plate and the read/write optical system do not have to be displaced.

In practical respect, it is an important requirement that the object and reference beams travel along the same way, i.e. that a so-called collinear optic arrangement is used. The object and reference beams passing along the same way and through the same optical elements are less sensitive to the environmental impacts, e.g. vibrations and airflow. In case of a collinear arrangement, the object and reference beams are mapped in a similar way. Thus, they overlap each other automatically and no separate servo system is required to control the overlap. The overlap of the object and reference beams is guaranteed by the strict tolerances in the manufacturing process.

In practice, it is preferable for holographic data storage devices that the data carrier operates in a reflective way. The transmission type holographic data carriers have the disadvantage that the writing and reading optical systems are located at different sides of the data carrier. This increases the dimension of the system perpendicular to the data carrier and makes it difficult to set the optical elements arranged on the two sides of data carrier into coaxial position and to preserve their coaxial position, respectively, by means of the servo mechanisms. An embodiment of the invention describes a data carrier and optical system of reflection arrangement.

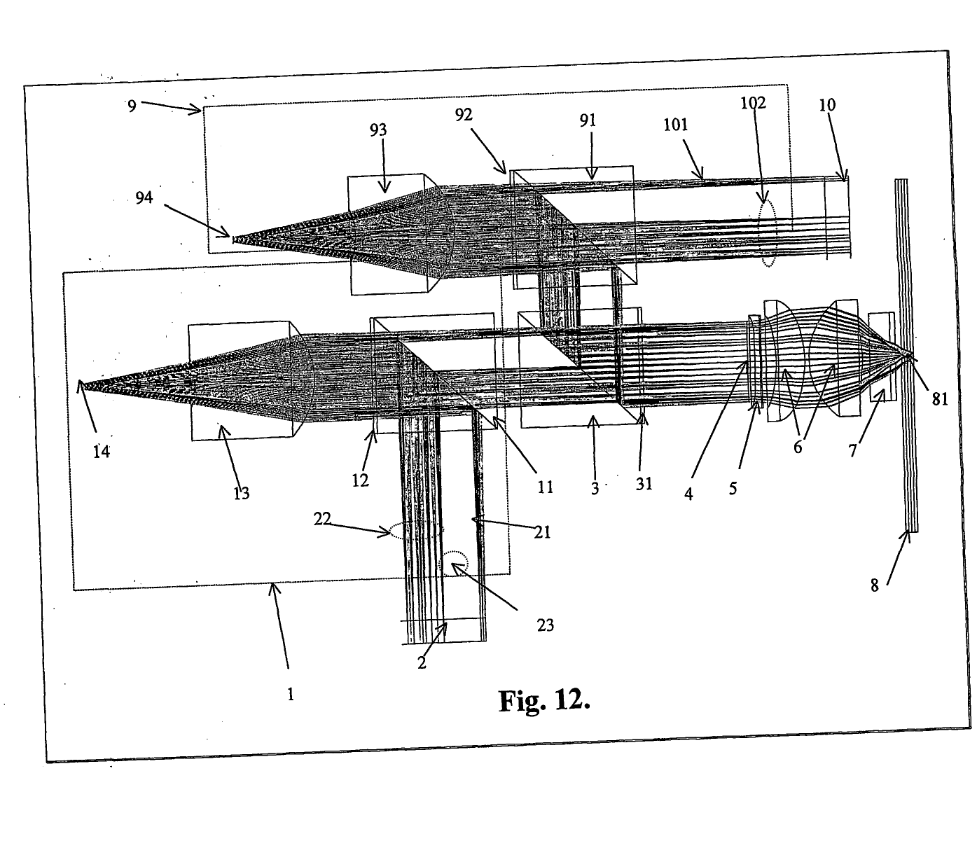

FIG. 12 shows a reflection type optical system with a collinear optical arrangement, suitable to be used for writing and reading multi-layer holographic data storage media, which meets the above requirements. The optical system consists of three main parts: a folded writing relay objective 1, a folded reading relay objective 9 and a writing/reading Fourier objective 6 composed of one or more lenses. The relay objectives are 4f objectives of relatively large focal length. The use of a relatively large focal length is justified by the requirement that the polarization splitting prism necessary for coupling and de-coupling of beams as well as λ/4 plates are able to be fitted into the 4f system without any difficulty. For practical reasons, it is important that the relay objective is of simple design and inexpensive. This can only be achieved by using a relatively large focal length and a small numeric aperture. The use of a folded system is justified by the fact that the dimensions of the system and, therefore, the number of lenses required can be reduced.

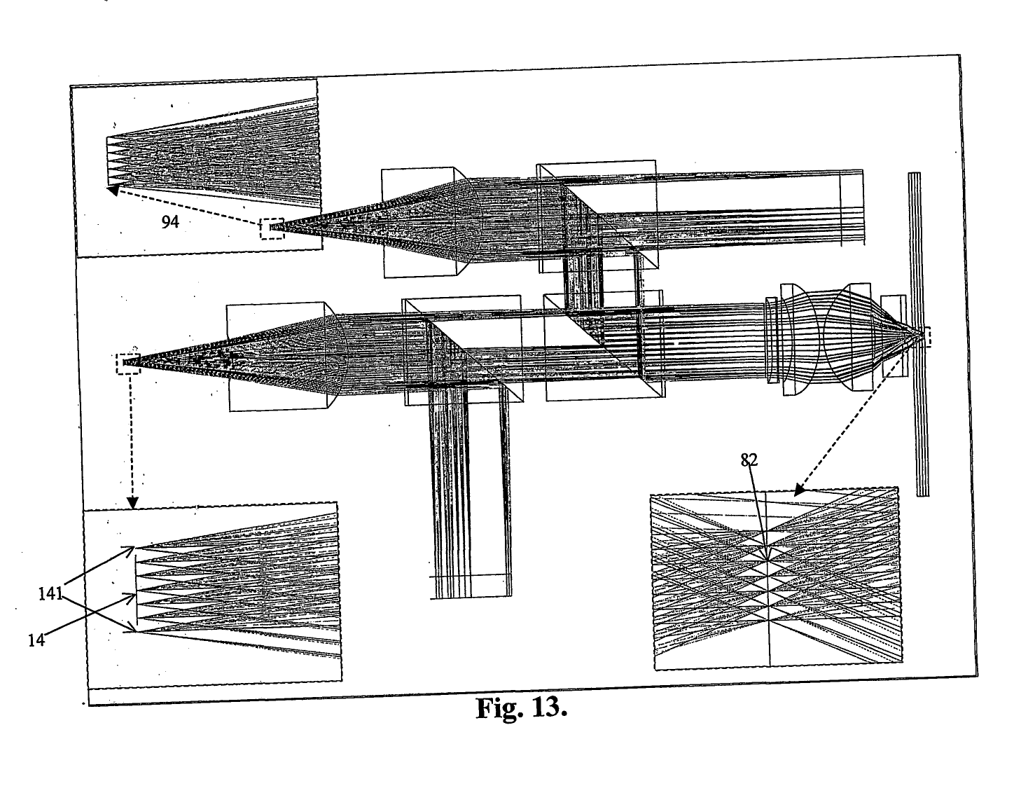

The writing relay objective is designed for generating the real and spatially filtered image of the SLM 2 on the inner image plane 4. The SLM 2 is located in the first focal plane of the lens 13 and the Fourier transform of SLM 2 is generated in the back focal plane 14. The spatial filter in the plane 14 cuts the Fourier components of higher order. The written-in Fourier hologram is the image of Fourier components that passed through the spatial filter 14. By optimizing the dimensions of the spatial filter, the data density that can be written into one hologram can be increased and the undesired interference between the holograms written close to each other in the same layer can be limited. FIG. 13 shows that the spatial filter 14 does not reflect higher order Fourier components 141.

The read/write Fourier objective 6 consists of an objective of short focal length and a large numeric aperture in the Fourier space. Basically, it is the numeric aperture of the objective in the Fourier space that determines the amount of data that can be written into one hologram. The objective has the task of generating the Fourier transform of the image created in the inner image plane 4 in the addressed layer during writing of holograms, and re-transforming the data signal from the addressed layer into the inner image plane 4 during reading. The addressing of layers is performed by the compensating plates 5 and 7. In the embodiment according to the invention, the distance between the holographic read/write head and the data carrier is constant. The space between the head and the data carrier is filled with an air layer and a plan-parallel compensating plate, respectively, of variable thickness depending on the depth of the addressed layer The compensating plate 7 of variable thickness has the task of geometrically shifting the back focal plane of the Fourier objective 6. It is well known that an object located below a plan-parallel plate of given thickness appears to be nearer than the geometric distance. Thus, in case of layers located at larger depth the back focal plane of the Fourier objective 6 moves away geometrically from the Fourier objective 6. However, due to the implantation of compensating plates 7 of variable thickness, the apparent distance remains unchanged in optical respect. When writing the uppermost layer, the compensating plate 7 is of zero thickness. With increased depth of the layer addressed, the thickness of compensating plate 7 increases and that of the air-layer decreases.

In FIG. 12 the folded writing relay objective 1 generates through the polarized beam splitting prism 3 an essentially distortion-free, real image of the spatial light modulator 2 on the inner image plane 4. The beam travels through the λ/4 plate 31. This turns the originally linearly polarized light into a circularly polarized light. The variable shape or variable optical characteristics read/write compensating plate 5 slightly modifies the direction of the rays. The compensator 5 of variable shape or variable optical characteristics does not have optical power on the optical axis. The shape of one or both surfaces of the variable shape or variable optical characteristics read/write compensating plate 5 depends on which layer has been addressed. The variable shape or variable optical characteristics compensating plate 5 may be an aspheric lens, a liquid lens, a liquid crystal lens or a different variable optical characteristics element. The Fourier objective 6 consisting of one or more section spherical or aspheric lenses generates the Fourier transform of the real image created on the inner image plane 4 of the SLM 2 in the addressed layer of the reflective data carrier 8. The addressing of the layers—which in principle requires a slight change in the back focal length of the read/write Fourier objective and hence the compensation of arising aberrations—is carried out jointly by the variable shape or variable optical characteristics write/read compensating plate 5 and the variable thickness planar read/write plane parallel compensating plates 7.

During the read-out, the read-out data signal is reflected by the reflective surface 81 of the reflective data carrier 8 and it proceeds through the variable thickness read/write plane parallel compensating plate 7, the read/write Fourier objective 6 and the variable shape or variable optical characteristics read/write compensating plate 5. The real image of the SLM 2, i.e. the read-out data signal, is generated on or in the vicinity of the inner image plane 4. The λ/4 plate 31 transforms the read-out beam into a beam normal to the writing beam and this polarized beam reaches via the polarized beam splitting prism 3 the folded reading relay objective 9. The read-out image is created on the surface of the detector array 10 by the folded relay objective 9.

The folded writing relay objective 1 consists of the polarized beam splitting prism 11, the λ/4 plate 12, the lens 13 and the reflective spatial filter 14. In the plane of the reflective spatial filter 14, the lens 13 generates the Fourier transform of the SLM 2. The reflective spatial filter 14 is a mirror of given size and shape with a specific aperture. The folded reading relay objective 9 consists of the polarized beam splitting prism 91, the λ/4 plate 92, the lens 93 and the reflective spatial filter 94. The lens 93 generates on the plane of the reflective spatial filter 94 the Fourier transform of the image created on the inner image plane 4. The reflective spatial filter 94 is a mirror of given size and shape with a specific aperture, which mirror is located confocally with the hologram read out from the addressed layer. In the plane of the SLM 2, the reference beams 21 and the object beam 22 are split in space. This enables the independent modulation of the reference beams 21 and the object beam 22. There is a prohibited (unused) area 23 between the reference beams 21 and the object beam 22. Neither an object beam nor a reference beam passes through this prohibited area. In the plane of the detector array 10, the reflected reference beams 22 and the read-out object beam 102 are spatially separated. This enables the independent detection of the reference beams 22 and the object beam 102, as well as the suppression of reference beams.

FIG. 13 shows a magnified picture of the applied 12f optical system, including the three Fourier planes in a confocal arrangement and their environment: the plane of the reflective spatial filter 14, the hologram written into the addressed layer 82 and the second reflective filter 94. The spatial filter 14 clips the higher order Fourier components 141.

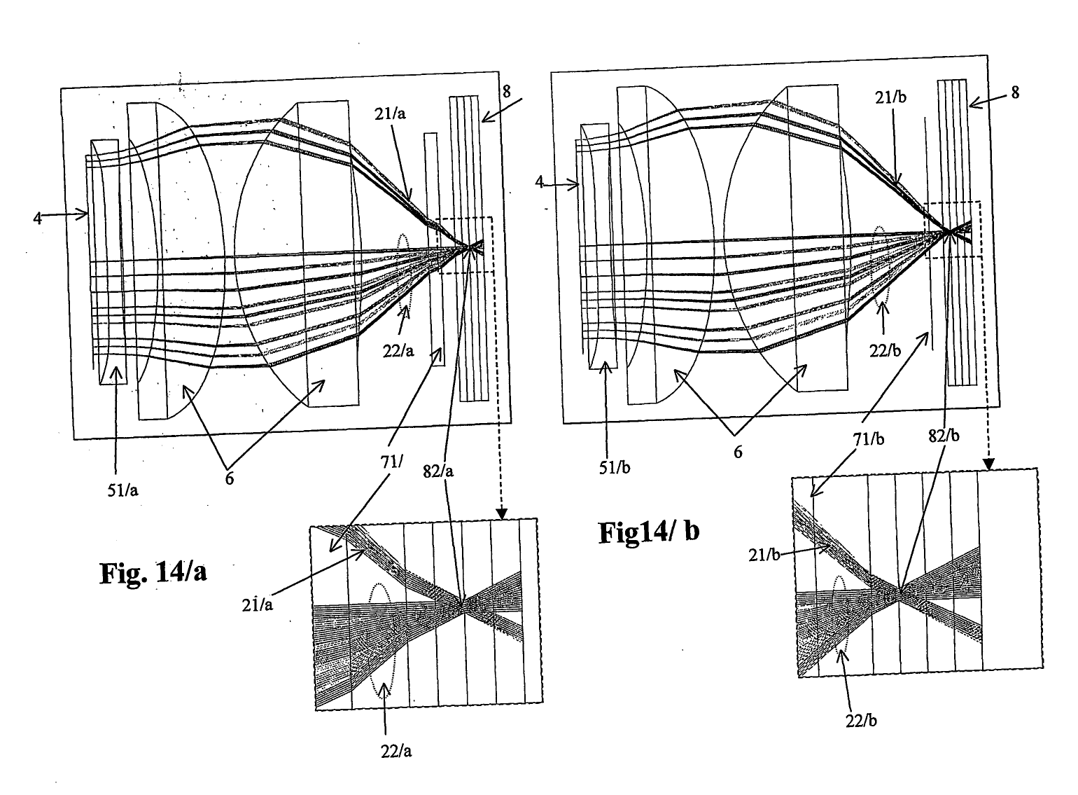

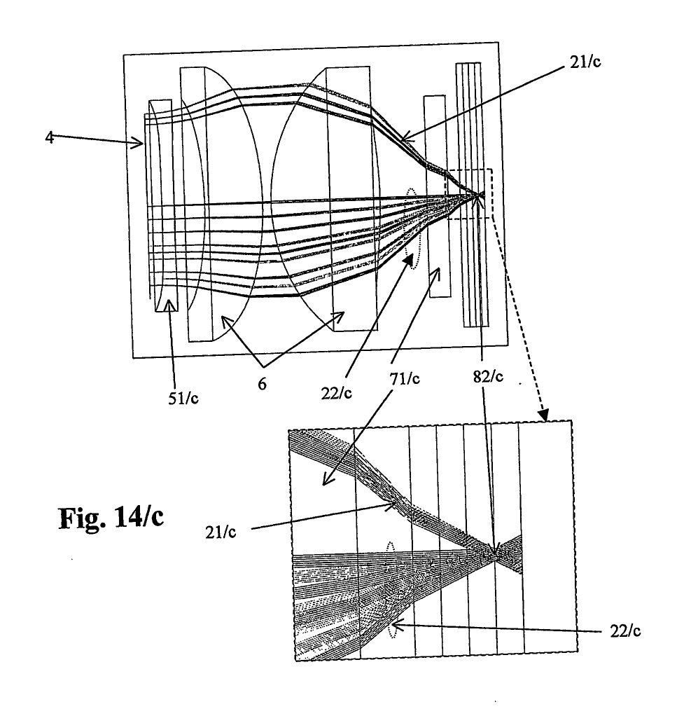

FIGS. 14/a, 14/b and 14/c show the process of writing the holograms into different depths of layers. The figures show a three-layer data carrier. In FIG. 14/a a hologram is written into the intermediate layer, in FIG. 14/b into the top layer, and in FIG. 14/c into the bottom layer. The image of the SLM is on the inner image point 4. In FIG. 14/a, the Fourier transform of the SLM image is created in the addressed plane 82/a. The hologram is generated in the environment of the addressed layer 82/a where the reference beams 21/a and the object beams 22/a intersect. In FIG. 14/b, the Fourier transform of the SLM image is created in the addressed plane 82/b. The hologram is generated in the environment of the addressed plane 82/b where the reference beams 21/b and the object beams 22/b intersect. In FIG. 14/c, the Fourier transform of the SLM image is generated in the addressed plane 82/c. The hologram is created in the environment of the addressed plane 82/c, where the reference beams 21/c and the object beams 22/c intersect. 71/a, 71/b and 71/c are variable thickness compensating plates. One surface of the variable shape or variable optical characteristics writing compensating plates 51/a, 51/b and 51/c is identical, and the other surface is different for all the three layers. The purpose of the variable shape or variable optical characteristics compensating plates 51/a, 51/b and 51/c is to change the direction of passing light beams slightly, thereby compensating the various aberrations arising in the addressing of each layer.

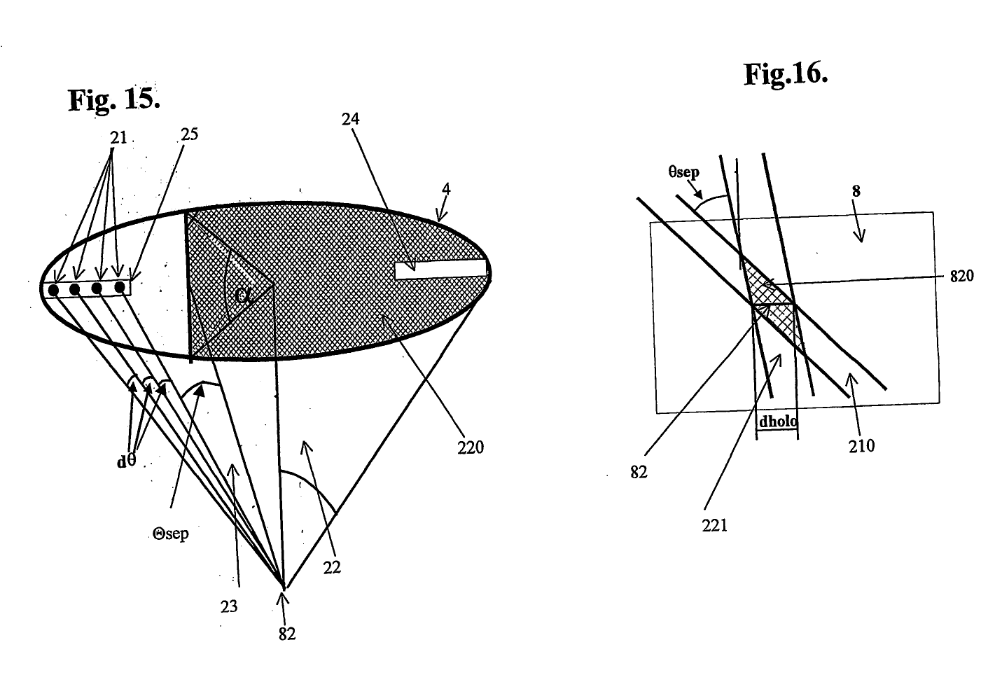

FIG. 15 shows a schematic view of the real image 4 of the SLM 2 and that of the addressed layer 82 (Fourier plane). Each reference beam 21 creates a dot in the plane of the real image 4. In the Fourier plane 82, each reference beam corresponds to an aperture limited ‘planar wave’. The object beam 22 originates from the data range 220 of the real image 4 of the SLM 2. The prohibited area 23, where no reference beam or object beam passes through, is located between the reference beams 21 and the object beam 22. The band 24 is that part of the data range 220 which is a center-related mirror image of the band 25 covered by the reference beams. During the reading, the read out data beam bouncing back from the reflective layer returns in the direction of the reading reference beam, consequently the band 24 may not be used for writing data.

FIG. 16 shows the cross section of the data carrier 8. 210 is the reference beam proceeding closest to the object beam. 221 is the outmost elementary beam of the object beam, which elementary beam travels closest to the reference beam. The reference beam 210 and the elementary object beam 221 are separated by exactly a Θsep angle. The intersecting range of the beams 210 and 221 is the elementary hologram 820, the centre line of which is the Fourier plane in the addressed layer 82.

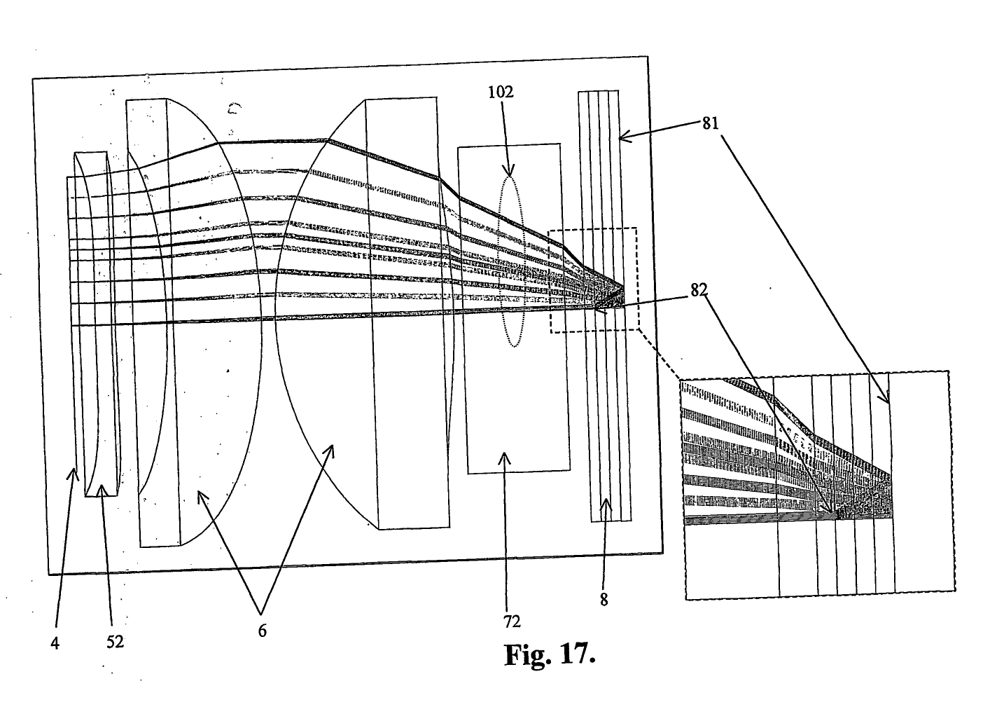

FIG. 17 shows the reading process. The read out data beam 102 originates from or in the vicinity of the Fourier plane in the addressed layer 82. The beam 102 reflects back from the reflective layer 81 and travels across the whole cross section of the data carrier 8 and also across the variable thickness compensating plate 72. The Fourier objective 6 re-transforms the Fourier transform in the addressed plane 82 to the inner image plane 4. The purpose of the variable shape or variable optical characteristics compensating plate 52 is the compensation of the aberrations arising due to the variable back focal length created by the compensating plate 72.

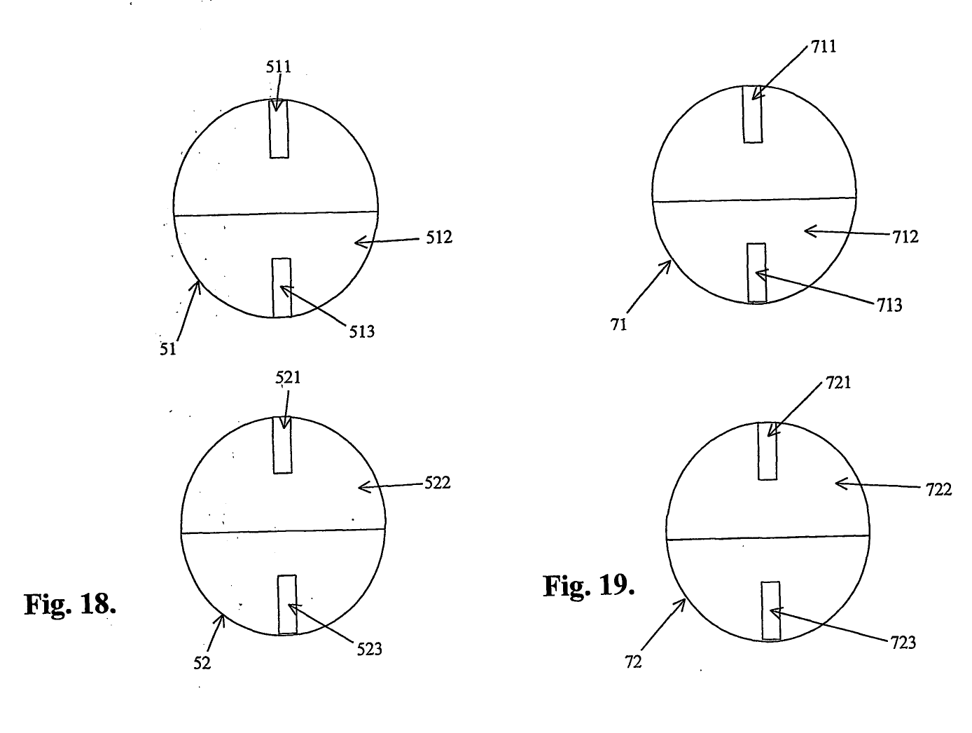

FIG. 18 shows the schematic view of the variable shape or variable optical characteristics compensating plates 51 and 52. In the course of writing the hologram, the reference beam travels across the range 511 towards the addressed layer. The reference beams bouncing back from the reflective layer 81 reach the detector via the range 513. The reading reference beams travel across the band 521 and are reflected by the range 523. During the writing process, the object beam proceeds across the range 512. The read out and reflected object beam is transformed to the inner image plane across the range 522.

FIG. 19 depicts the schematic view of the variable-thickness compensating plate 72. During hologram writing, the reference beam travels across the range 711 towards the addressed layer. The reference beams bouncing back from the reflective layer 81 reach the detector via the range 713. The reading reference beams travel across the band 721 and are reflected by the range 723. During the writing process, the object beam travels across the range 712. The read out and reflected object beam is transformed to the inner image plane via the range 722.

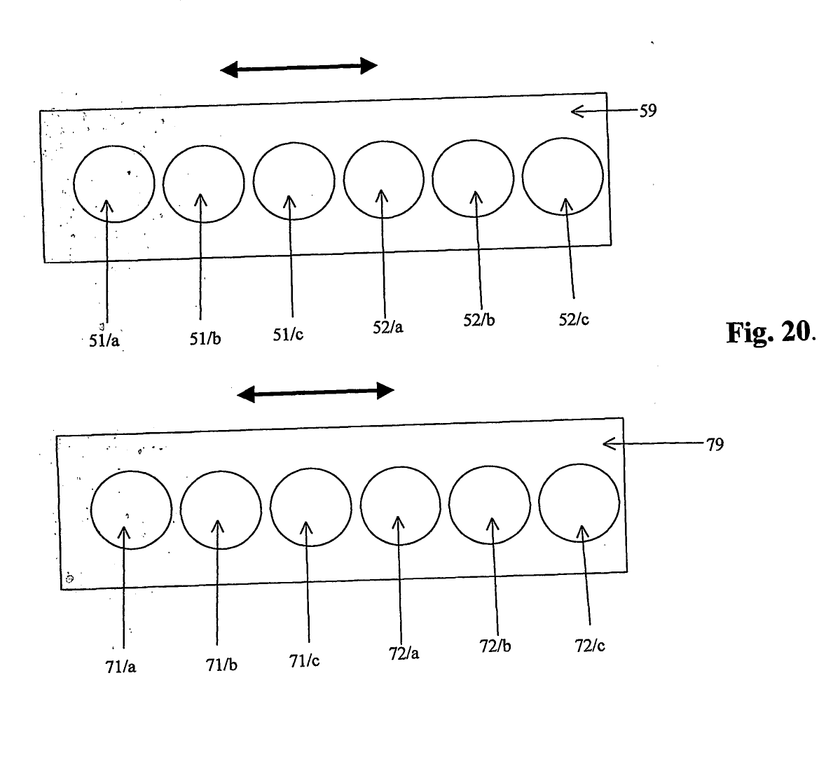

FIG. 20 shows the mobile linear elements 59 and 79. The variable shape writing compensating plates 51/a, 511b and 51/c, and the variable shape reading compensating plates 52/a,52/b and 52/c are on the mobile linear member 59. The variable thickness writing compensating plates 71/a, 71/b and 71/c, and the variable shape reading compensating plates 72/a, 72/b and 72/c are on the mobile linear member 79.

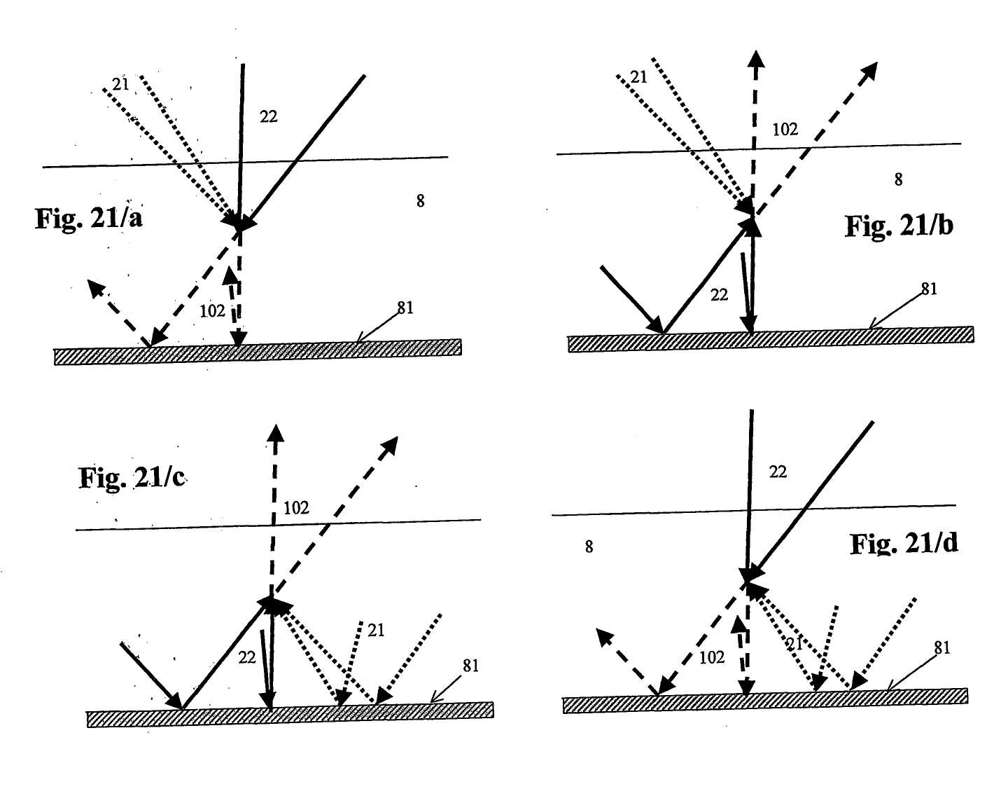

FIG. 21 shows a schematic view of the possible arrangements of the object and reference beams. In FIG. 21/a, during hologram writing, the reference beam 21 and the data beam 22 are direct beams. The read out data beam 102 travels by reflecting back from the reflective layer 81.

In FIG. 21/b, during hologram writing, the reference beam 21 is a direct beam, and the object beam 22 reaches the addressed layer by bouncing back from the reflective layer 81. The read out data beam 102 is a direct beam and it travels in the direction of the reading head without reflection. In FIG. 21/c, during hologram writing, the reference beam 21 and the object beam 22 reach the addressed layer by bouncing back from the reflective layer 81. The read out data beam 102 is a direct beam and it travels without reflection towards the reading head. In FIG. 21/d, during hologram writing, the reference 21 reaches the addressed layer by bouncing back from the reflective layer 81, and the data beam 22 is a direct beam. The read out data beam travels towards the reading head by bouncing back from the reflective layer 81.

FIGS. 14/a, 14/b and 14/c show the process of hologram writing into the layers of various depth. The figures show an exemplary three-layer data carrier. However, the data carrier according to the invention can include more or less layers and the equipment according to the invention is also capable of writing and reading more or less layers, respectively. Writing of hologram takes place into the middle layer in FIG. 14/a, the highest layer in FIG. 14/b and the lowest layer in FIG. 14/c. Accordingly, the writing compensating plate 71/c is the thickest one whereas 71/b is the thinnest one. The writing compensating plate 71/b may even be of zero thickness. The image of SLM appears at the inner image plane 4. In principle, the image is distortion free in optical geometric sense. In FIG. 14/a, the Fourier transform of the SLM image is created in the addressed layer 82/a. The hologram is generated in the region of the addressed layer 82/a where the reference beams 21/a and the object beams 22/a overlap each other. In FIG. 14/b, the Fourier transform of the SLM image is created in the addressed plane 82/b. The hologram is generated in the region of the addressed layer 82/b where the reference beams 21/b and the object beams 22/b overlap each other. In FIG. 14/c, the Fourier transform of the SLM image is created in the addressed plane 82/c. The hologram is generated in the region of the addressed layer 82/c where the reference beams 21/c and the object beams 22/c overlap each other.

As a result of the variable back focal length and the ratio of variable air-gap to the compensating plate thickness, the behavior of beams in the focal plane of Fourier objective 6 is slightly different in each layer. They intersect each other in a different way in each layer, the wave front is slightly different in each layer, i.e. different aberrations occur when addressing the various layers. This increases the size of the focal spot (Fourier plane), thus increasing the interference between the holograms written near to each other in the same layer, which, in turn, makes it difficult to separate the holograms read from the various layers at the same time by means of the confocal filter 94. Finally, each effect leads to the reduction of storage capacity. The aberrations that may occur can be eliminated by inserting an additional compensating plate. The compensating plate 5 is located in front of the objective. As a general rule, the compensating plate 5 is an optical element arranged in the inner image plane 4, which is capable of modifying the wave front of light entering into and, in case of reading, emerging from the objective 6 to an extent necessary for eliminating the aberrations that may occur when addressing the layers.

In FIGS. 14/a, 14/b and 14/c, the first surfaces of the writing compensating plates 51/a, 51/b and 51/c of variable shape or variable optical properties are of the same shape, while their second surfaces are different for each of the three layers. Their task is to compensate for the aberrations by slight modification of the direction of beams originating from the image created in the inner image plane 4. In other words, the writing compensating plates 51/a, 51/b and 51/c of variable shape or variable optical properties are designed for modifying the wave front in or very near to the inner image plane 4. Thus, the beam entering into the Fourier objective 6 takes slightly different shape when addressing the individual layers. The difference is just equal to the extent necessary for the correction of aberration that may occur when addressing the individual layers. The thickness of the compensating plates 51/a, 51/b and 51/c of variable shape or variable optical properties remains the same along the optical axis and is independent of the depth of the addressed layer. Their refractivity at the optical axis is zero.

According to an exemplary embodiment, the compensating plate 5 of variable shape or variable optical properties consists of an aspheric plate, where the shape of one or both sides of which depends on the depth of the addressed layer. In such cases, the compensating plate 5 shall be replaced when addressing the layers.

In another exemplary embodiment, one side of the compensating plate 5 holds an aspheric plate while the other side holds a variable liquid crystal lens. In this embodiment, the aspheric surface is constant for each layer. Only the distribution of refraction index of the liquid crystal lens varies under the effect of an appropriate electric control signal applied to the liquid crystal lens, when addressing the layers.

In a further exemplary embodiment, one side of the compensating plate 5 holds an aspheric plate while the other side holds a variable shape liquid lens. In this embodiment, the aspheric surface is constant for each layer. Only the shape of the liquid lens varies under the effect of an appropriate electric control signal applied to the liquid lens when addressing the layers.

The compensating plate 5 may also be a lens made of single-axis crystal placed between two polarizer plates. A well known feature of double-refracting lenses is that the spherical aberration that may occur can be compensated by setting polarizer plates located both before and behind the lens.

FIG. 13 shows the opened schematic diagram of a part of the folded 12f optical system. The opened system means that the original reflection elements are of transmission type here, i.e. the beams are separated before and after the hologram. In the opened transmission type system there are no reflecting and overlapping beams. Thus, the function of spatial filtering which is one of the essential elements of the invention can be better understood. In practical respect, the folded system is more favorable. It contains less number of elements, it is less sensitive to environmental impacts.

In the 12f system, two inner image planes are developed, one before and another after the Fourier objective. In the folded system, these two inner image planes coincide. The object and reference beams are separated in the plane of the spatial light modulator 2, in the inner image plane 4 between the relay objectives and the Fourier objective as well as in the detector plane. In these three planes, the object and reference beams can be modulated or detected independently of each other and can be coupled or de-coupled within these planes without disturbing each other. The location of object and reference beams in the inner plane 4 is shown in FIG. 15. In the optical system shown in FIGS. 12 and 13, coupling of the object and reference beams takes place in the plane of the SLM 2. According to another embodiment, the object and reference beams can be coupled and de-coupled, respectively, in the inner image plane as well.

The multi-layer holographic data storage and the well known angle or phase coded reference multiplexing can be combined in a simple way in case of a collinear optic arrangement. In case of angle or phase coded multiplexing, the hologram is illuminated by using aperture limited planar wave reference beams in a geometric optical approach. Before the write/read Fourier objective 6 in the inner image plane 4, to each reference beam a point source is assigned in a geometric optical approach. (In a diffraction approach, a diffraction spot determined by the size and shape of aperture instead of an aperture limited planar wave, while an extended source instead of a point source shall be taken into consideration). FIG. 15 shows the schematic diagram of the real image 4 of the SLM 2 as well as that of the addressed layer 82 (Fourier plane). The SLM is of circular shape in conformity with the circular object area of the polar-symmetric Fourier objective. According to the above, the reference beams 21 create a point each in the real image plane 4 in geometric optical sense. If no multiplexing exists, only one reference beam is required. In the Fourier plane 82, to each reference beam in the Fourier plane an aperture limited ‘planar wave’ is assigned. There exists an angle difference of dΘ between the ‘planar waves’, which is determined by the Bragg's condition depending on the thickness of the layer. The object beam 22 originates from the data range 220 of the real image 4 of SLM 2. There is a prohibited area 23 between the reference beams 21 and the object beam 22. Neither an object beam nor a reference beam passes through this area. The optimum size and shape of the prohibited area depends on the distance between layers and on the number of holograms written (multiplexed) into a single place. The angle of sight of the prohibited area 23 viewed from the addressed layer 82 (Fourier plane) is Θsep. The required and optimum angle of sight, respectively, Θsep depends on the distance between the storage layers and the size (diameter) of holograms as well as the number of holograms multiplexed into a single place. A larger size of holograms requires a larger distance between the layers or a larger angle of separation. Theoretical calculations show that the data amount that can be stored in a single hologram (data density) reaches its optimum if the data range of the circular SLM 220 is approximately semi-circular.

From a practical point of view, an optimum embodiment of this invention is the folded 12f optical system shown in FIG. 12 and FIG. 13. In the 12f system, there are three Fourier planes in confocal arrangement. The essence of the invention is that the three Fourier planes of the 12f optical system are in exact object/image relation. FIG. 13 shows a magnified view of the Fourier planes and their environment, i.e. the plane of the reflective spatial filter (Fourier filter) 14, the hologram written into the addressed layer 82, and the second reflective spatial filter (confocal filter) 94. The spatial filter 14 cuts the higher order Fourier components 114. Cutting the higher order Fourier components enables the size of the hologram to be reduced, thus increasing the data density stored in a single hologram. The size of the hologram, the distance between layers and the number of holograms that can be multiplexed in a layer are closely interrelated. Cutting the higher order Fourier components 141 reduces the interference between the holograms located close to each other in the same layer. This means that, by proper setting of the size of reflective spatial filter 14, the data storage capacity of the system can be optimized. The reflective spatial filter 94 is designed for filtering out the holograms read from un-addressed layers.

FIG. 17 shows the reading process. When reading, the object beams originating from the addressed layer 82 are reflected by the reflective surface of the data carrier and arrive at the write/read Fourier objective consisting of the lenses 6. The back focal length becomes still larger than that used in writing the same layer, which can be implemented by using a thicker compensating plate 72. In other words, the reading compensating plate 72 is always thicker than the writing compensating plate 71 associated with the same layer. Accordingly, when reading, the shape of the aspheric plate of variable shape 52 used to compensate the aberrations due to the layer thickness also differs from that of the aspheric compensating plate 51 used for writing the same layer.

However, the write/read compensating plates used for writing and reading of the same layer, respectively, differ not only in their thickness and shape. A significant difference results from the fact that, when writing holograms, the object and reference beams originate from ranges spatially separated in the inner image plane 4 and also pass through the Fourier objective 6 separated spatially. In case of reading, however, the object beam 102 read out is reflected on the reflecting surface 81 and passes through the range of the Fourier objective 6 where the reference beam used for reading travels towards the addressed hologram. This means that, during reading, the reading reference beam and the read-out object beam 102 passing through the compensating plates 52 and 72, although in opposite directions, would overlap each other. Therefore, the range 24 (see FIG. 5) is eliminated from the object beam. FIGS. 18 and 19 show the overlap ranges 521 and 721 on the compensating plates 52 and 72. As the reference beam shall be completely identical to that used for writing the hologram, the shape and optic characteristics of the reading compensating plate in the range 521 correspond to the shape of the writing compensating plate 51 in the range 511. The task of the ranges 511 and 521 is to compensate the aberrations that may occur when focusing the reference beams. The range 512 and the range 522 compensate the aberrations occurring in the object beam during writing and reading, respectively. The ranges 513 and 523 are designed for correcting the aberrations occurring in the reflected reference beams. The reflected reference beams can be used for detecting the correct positioning of the compensating plates. The compensating plates 71 and 72 also consist of two ranges of different thickness. The reference beams pass through the range 711 during writing and through the range 721 during reading. The reflected reference beams pass through the bands 713 and 723, respectively, towards the detector. The thickness of bands 711 and 721 is the same as that of the range 712. On the bands 713 and 723 as well as the range 722 the compensating plate is of larger thickness, according to the larger back focal length necessary for reading the reflected beams. In respect of their embodiment, the plates 51, 52 and 71, 72 are mould plastic elements, that can be produced in large series at low cost.

It follows from the above that the writing compensating plate 51 and the reading compensating plate 52 are replaced when addressing the individual layers, or the elements have optical characteristics (shape and/or variation of refractivity distribution) that can be controlled by electric signals. Similarly, the writing compensating plate 71 and the reading compensating plate 72 are also replaced. This can be implemented by means of a one-dimension driving element for each compensating plate that move before and after the Fourier objective 6 for a constant distance from the Fourier objective 6. As shown in FIG. 20, the writing compensating plates 51/a, 51/b, and 51/c and the reading compensating plates 52/a, 52/b and 52/c associated with the layers are mounted on the linear element 59. The writing compensating plates 71/a, 71/b, and 71/c and the reading compensating plates 72/a, 72/b and 72/c are mounted on the linear element 79. Here again, a three-layer data carrier is assumed. In case of writing or reading, the linear elements 59 and 79 is moved into a proper position relating to the objective 6 for addressing the layers. The compensating elements 51, 52, 71, and 72 can also be mounted on a circular disc. In this case, the disc is rotated for addressing the layers.

In case of a holographic data storage system, it is an important requirement that the reference beam is the same when writing and reading holograms. With replaceable compensating plates, this means that the positioning of the plates of variable shape 51 and 52 is very crucial. Restoring the plates 71 and 72 is not crucial, because the plates of variable thickness are plan-parallel plates. They are moved parallel to the plane. Thus, their repositioning is not crucial. The reference beam reflected on the reflecting surface 81 reaches the detector 10 in case of both writing and reading holograms. During writing, the accurate thickness of bands 711, 713 depending on the addressed layer and the accurate shape of bands 511, 513 depending on the addressed layer ensure in principle that the reflected reference beams reach the detector matrix correctly. Similarly, during reading, the accurate thickness of bands 722, 723 and the accurate shape of bands 521, 523 ensure that the reflected reference beams reach the detector matrix correctly. If, during addressing the layers, the compensating plates 51 and 52 are not in place accurately, the reflected reference beams 22 reach the surface of the detector 10 at a place different from the position determined theoretically. This generates an error signal for the accurate setting of the plates 51 and 52.

In another embodiment of the compensating plates 51 and 52, one surface of the compensating plate consists of a liquid crystal lens, while the other surface is an aspheric surface that is identical for each layer independently of the addressed layer. When using a liquid crystal lens, the compensating plates 51 and 52 are not replaced when addressing the layers. Under the effect of an appropriate electric control signal applied to the liquid crystal lens, the refractivity distribution of the lens varies. This slightly modifies the direction of the light beams, thus implementing the compensation of aberrations that occur during addressing the various layers. Similarly, the compensating plates 51 and 52 are not moved if the plate is designed in the form of liquid lens or double-refracting lens.

In the 12f optical system shown in FIG. 12, the reference and object beams travel together along their path while appearing to be separated. The reference and object beams are also spatially separated in the inner image plane 4 This enables the coupling of the reference and object beams even in this plane. In this case, the reference beams do not pass through the folded writing relay objective 1 This solution is more sensitive to the environmental impacts. However, it also offers more possibilities and freedom in modulating the reference and object beams independently of each other.

In the system shown in FIG. 12, the reference beams pass through the right side while the object beams pass through the left side of the SLM. In principle, the capacity of the system can be doubled if the object and reference beams also travel in parallel in the same layers as compared to that shown in FIG. 12. That is, two times as many holograms are multiplexed in each layer. One half of the multiplexed holograms is written by means of the reference beams passing through the right side and the object beams passing through the left side of the SLM, while the other half of the holograms is written by means of the reference beams passing through the left side and the object beams passing through the right side of the SLM. In case of double multiplexed holograms, the fundamental relationships between the size of the holograms, the distance between the written layers, the number of multiplexed holograms and the angle of sight of the prohibited area do not change. However, the capacity is doubled.

In the system shown in FIG. 12, both the object beam and the reference beam are direct beams during the writing of holograms. This means that, when writing, the beams reach the addressed layer without touching the reflective layer 81. On the other hand, the read data beam is reflected by the reflective layer and travels toward the reading head. There may be embodiments in which during reading, either the reference or the data beam or both are reflected by the reflective surface 81 first and, then, reach the addressed layer. FIGS. 21/a to 21/d show the possible arrangements of the object and reference beams. If, during writing, the object beam is reflected, the read-out data beam 102 reaches the reading head without touching the reflective surface 81. The arrangements shown in FIGS. 21/a to 21/d result in different holograms, that is, different grid structures. The arrangements presented enable holograms to be written into the same place, that is, to be multiplexed. In principle, this increases the capacity of the system fourfold. Of course, in case of arrangements of object and reference beams according to the FIGS. 21/a to 21/d, the compensating plates 5 and 7, as well as the ranges 511, 512, 513, 521, 522, and 523 on the writing plate 51 and on the reading plate 52 as shown in FIG. 18 and the ranges 711, 712, 713, 721, 722, and 723 on the writing plate 71 and reading plate 72 as shown in FIG. 9 are also modified accordingly.

The optical system is largely simplified if only one bit of information is stored in each micro-hologram. In such cases, no spatial light modulator is needed for writing, while the reading takes place by using a simple photo-detector. The advantage of the holographic storage, however, to write and read data in parallel, will be lost. Depending on the properties of the storage layer, the method of physical recording of micro-holograms may be intensity hologram, polarization hologram, or amplitude or phase hologram. The storage procedure described above functions in each case.

Each of the embodiment described above can be implemented in a manner that one or more data storage layers consist of pre-printed and computer generated holograms. This results in a non-rewriteable read only storage medium with the important advantage that it can be reproduced in serial production, similarly to CD/DVD discs. The refractivity of storage layers and that of spacer layers is different. The pre-printed hologram consists of a complex diffraction grid, the product of the Fourier transform of the spatial light modulator and the reference beam, i.e. a computer generated hologram to deviate the reference beam. The pre-printed hologram may be a thin phase hologram.

1-71. (canceled)

72. Method for volumetric holographic data storage, wherein holograms are written into at least one volumetric data storage layer, the accurate places of holograms in a storage layer during writing being determined by the intersection range of at least one object and at least one reference beam, wherein during reading the selection of holograms simultaneously illuminated by at least one reference beam, the read-out of an addressed hologram, and the suppressing of un-addressed holograms are carried out by a spatial filter located confocally with the addressed hologram.

73. Method according to claim 72, wherein the holograms are written either one by one or multiplexed into stacked layers, such that they partly overlap within a layer and/or between layers.

74. Method according to claim 72, wherein the holograms are written by a two wavelength process, where in addition to an object and a reference beam of identical wavelength, a sensitizing beam with a different wavelength is applied.

75. Optical system for reading and recording holograms in a volumetric storage material, the system generating at least one object beam and at least one reference beam for recording a hologram on a data carrier, and at least one reference beam for reading a hologram from the data carrier, wherein the system has three dedicated planes in confocal arrangements, an addressed hologram being located in the middle dedicated plane, and spatial filters, whose size is determined by the magnification of the optical system, being located in the two outer dedicated planes.

76. Optical system according to claim 75, wherein the system is a 12f optical system consisting of three pairs of objectives, the first member of an objective pair generating the Fourier transform of an object, and the second member of the objective pair re-transforming the object, the image of the object always being created in the back focal plane of the second member of the objective pair.

77. Optical system according to claim 76, wherein a spatial light modulator for writing data is located in the first focal plane of the first objective pair, and wherein a filter aperture is located in the joint focal plane of the first objective pair, which cuts the higher orders of the Fourier transform of the spatial light modulator and only transmits a part of the zeroth diffraction order, such that in the back focal plane of the first objective pair a spatially low pass filtered image of the spatial light modulator appears.

78. Optical system according to claim 77, wherein the first focal plane of the first member of the second objective pair coincides with the back focal plane of the first objective pair, such that the spatially low pass filtered image of the spatial light modulator is Fourier transformed by the first member of the second objective pair into the joint focal plane of the second objective pair for intersection with at least one reference beam, and wherein the data carrier is located in or near the joint focal plane of the second objective pair.

79. Optical system according to claim 78, wherein the first focal plane of the third objective pair coincides with the back focal plane of the second objective pair, and wherein a spatial filter aperture is located in the joint focal plane of the third objective pair, such that in the back focal plane of the third objective pair a filtered image of the spatial light modulator appears, and wherein a detector array is located in the back focal plane of the third objective pair.

80. Optical system according to claim 76, wherein the first objective pair and/or the third objective pair is replaced by a folded objective, having a polarization splitting cube, a λ/4 plate, a Fourier objective and a mirror, the mirror being located in the focal plane of the Fourier objective and having a well defined aperture.

81. Optical system according to claim 76, wherein the at least one reference beam travels along the common optical axis of the objectives in a direction identical with that of the at least one object beam, and wherein the reference beam is a dot (pixel) in the plane of the spatial light modulator or in corresponding conjugated image planes in the centre of the spatial light modulator in confocally located Fourier planes clipped in parallel with the common optical axis of the objectives.

82. Optical system according to claim 81, wherein in the centre of the at least one object beam a space of appropriate size is left for the at least one reference beam, and wherein around the Fourier planes the at least one object beam travels in a cone having an inner cone within the cone in which there is no object beam.

83. Optical system according to claim 82, wherein the distance of the layers, the size of the holograms and the conic angle of the cone with the inner cone within the at least one object beam are selected such that out of the holograms illuminated simultaneously by the at least one reference beam, the spatial filter in the joint focal plane of the third objective pair only passes the object beams coming from the addressed layer, while the object beams coming from un-addressed holograms are blocked.

84. Optical system according to claim 81, wherein the at least one reference beam and the at least one object beam traveling along the common optical axis of the objectives travel in opposite direction, and wherein a reflective hologram is created in the addressed layer.

85. Optical system according to claim 76, wherein the at least one reference beam includes an angle γ with the common optical axis of the objectives in the Fourier planes, and wherein the at least one object beam travels in the Fourier space within a half-conic angle cone, while the object points are located within a circle of radius R in the image and object space.

86. Optical system according to claim 85, wherein the distance of the storage layers, the size of the holograms, the conic angle of the object beams and the angle γ included between the at least one reference beam and the optical axis are selected such that out of the holograms illuminated simultaneously by the at least one reference beam, the spatial filter in the joint focal plane of the third objective pair only passes the object beams coming from the addressed layer, while the object beams coming from un-addressed holograms are blocked.

87. Optical system according to claim 76, wherein the spatial light modulator is illuminated by a spherical wave of variable radius of curvature, and wherein during writing and reading the addressing of a layer is implemented by changing the radius of curvature of the spherical wave illuminating the spatial light modulator and by appropriately adjusting the position of the spatial filters.

88. Optical system according to claim 76, wherein during writing and reading the addressing of a layer is implemented by an interrelated displacement between the storage material and the optical system, and wherein spherical aberration arising from the interrelated displacement is compensated by variable thickness transparent plates located before and after the storage material.

89. Optical system according to claim 88, wherein the variable thickness transparent plates are plane parallel plates of a stepwise varying thickness located between the two objectives of the second objective pair.

90. Optical system according to claim 88, wherein a storage medium carrying the holograms is situated in a slanted position between the objectives of the second objective pair.

91. Optical system according to claim 76, wherein during writing and reading the distance between a storage medium and the objectives of the second objective pair is constant, and wherein a variable back focal length of the second objective pair is created by the contribution of variable thickness, variable shape or variable optical characteristics elements before and after the second objective pair.

92. Optical system according to claim 91, wherein variable thickness, variable shape or variable optical characteristics elements are replaceable, or mounted on a linear actuator, or mounted on a rotary disk.

93. Optical system according to claim 91, wherein direct beams traveling towards a storage medium and beams reflected by the storage medium pass through different domains of the variable shape or variable optical characteristics domains.

94. Optical system according to claim 91, wherein a first variable thickness, variable shape or variable optical characteristics element is an aspheric lens, and wherein a second variable thickness, variable shape or variable optical characteristics element is a liquid crystal lens, a controllable liquid lens, or a controllable double refraction lens.

95. Optical system according to claim 76, wherein the at least one objective beam and the at least one reference beam are spatially separated in the plane of the spatial light modulator, in the inner image plane, and in the plane of the detector array.

96. Optical system according to claim 76, wherein the at least one objective beam travels across one half of the spatial light modulator, and the at least one reference beams travels across the other half of the spatial light modulator, and wherein holograms generated by the at least one object beam and the at least one reference beam located in an axial symmetry in relation to each other are multiplexed in an identical position.

97. Optical system according to claim 76, wherein the at least one object beam and/or the at least one reference beam are either direct beams during the writing process or reach the addressed layer after reflection by the reflective layer, and wherein the read out object beam reaches a reading objective after reflection by the reflective layer or directly.
